(19) United States
(12) Patent Application Publication
(10) Pub. No.: US 2012/0059759 A1
(43) Pub. Date: Mar. 8, 2012

(54) FUNDRAISING SYSTEMS AND METHODS

(75) Inventors: Adam Bagarella, Medford, MA (US); David W. Sampson, Boxford, MA (US)

(73) Assignee: RABICAN COMPANIES, INC., Danvers, MA (US)

(21) Appl. No.: 13/224,510

(22) Filed: Sep. 2, 2011

Related U.S. Application Data
(60) Provisional application No. 61/379,550, filed on Sep. 2, 2010.

(51) Int. Cl. G06Q 99/00; G06Q 40/00

(52) U.S. Cl. 705/39; 705/329

(57) ABSTRACT

A method of facilitating pledges of monetary value between a pledgee and pledgor, the method including the steps of providing a graphical user interface having a plurality of selectable performance metrics and at least one input for a factor of monetary value, receiving a selected performance metric of the plurality of performance metrics and the at least one input for a factor of monetary value, transmitting and storing the received selected performance metric and the received input of a factor of monetary value to computer readable memory of a computer server system, periodically querying and obtaining a measured value of the selected performance metric and storing said measured value in the computer readable memory of the computer server system, and calculating a pledge amount of monetary value by applying said factor of monetary value to the measured value of the selected performance metric and storing the pledge amount of monetary value in the computer readable memory of the computer server system.

### RELATED APPLICATIONS

This application claims the benefit of U.S. Provisional Application No. 61/379,550, filed Sep. 2, 2010, the contents of which is herein incorporated by reference in its entirety.

### FIELD

Embodiments of inventive concepts relate to methods and systems for conducting fundraising activities over networks, including the Internet.

### BACKGROUND

Despite the age and size of the fundraising industry, little progress has been made towards overcoming the inherent obstacles of traditional fundraising. In most forms as it exists today, it is an inefficient industry that requires large amounts of time and money to run campaigns. Because such a large portion of raised funds are consumed by these high costs, the percentage of donations that are actually allocated to the cause itself is staggeringly low. Additionally, the inefficiency is further exacerbated by the fact that these costly efforts are limited at generating donor contributions. This combination of high cost and low efficacy remains the status quo for the industry.

The inefficiency of traditional fundraising stems largely from a single crucial assumption: the expectation that potential contributors will be sufficiently motivated to donate purely based on the desire to give. By operating under this belief, fundraising organizations effectively lock themselves into a dependence on costly solicitation techniques to generate donations. To make matters worse, these solicitation techniques require significant manual effort in order to be successful, which further drives up cost. From door-to-door tactics to direct mail campaigns to cold calling to live television/radio events, these high cost campaigns are virtually unavoidable under the traditional system. It's a model that relies on human interaction to be effective, and because of that, less expensive automated systems become impractical. The end result is an industry dependent on a technique that is very costly and relatively ineffective.

In recent years, some progress has been made towards breaking away from the traditional fundraising model by using the Internet as a medium for fundraising efforts. There are a number of organizations that have a presence on the web, some of which are actual charities or fundraising groups, and some of which are strictly web applications that facilitate online donations by acting as a middle-man between donors and fundraising entities. Unfortunately, while these organizations have made the move to a more automated process on the Internet, they are still relying on only a slightly modified version of traditional solicitation based techniques. Donors can make donations through the Internet, but the expectation still exists for users to proactively seek out these fundraising entities and choose to donate with the primary motivation still being the core desire to give. For this reason, web based donations continue to represent only a minute percentage of donations made in the fundraising industry. While these organizations have taken the first step towards overcoming the inherent issues with traditional fundraising by allowing automated collections, it is far from a complete solution. Fundraising on the Internet has yet to take the quantum leap to its next stage of evolution.

### SUMMARY

Embodiments of the inventive concepts described herein provide systems and methods for conducting fundraising activities over networks including, for example, the Internet. Various embodiments address streamlining the front and back end processes involved in fundraising efforts and methods for supporting such systems.

Various embodiments provide a model around performance-based donations in which donors can pledge monetary amounts against performance metrics that arise out of any event that produces quantifiable metrics.

Embodiments are directed to fundraising systems and methods built around reducing cost and increasing efficiency of fundraising activities. In an embodiment, donations are generated via pledges against measurable performance metrics arising from any event that produces such metrics. Such events may include but are not limited to professional sporting events, collegiate sporting events, regional/local sporting events, Olympic sporting events, stock market performance, a movie's opening weekend, or a political election. An embodiment includes ensuring that performance metrics are clearly definable and verifiable. An embodiment provides a system that is highly automated at all levels of the fundraising process. An embodiment is provided on the Internet including a standardized and widely accessible interface, to accommodate the largest pool of potential participants possible. Donations may be accepted from both individuals and organizations, to further enlarge that pool. An embodiment includes a user interface that is simple, straight-forward, and user-friendly to facilitate the donation process and increase the likelihood of donor participation. User account data and payment information may be stored in a computer system to simplify repeat donor participation and increase user retention. Through a primarily performance-based donation model, embodiments can provide high levels of user engagement and interactivity, providing potential donors with substantially more motivation to participate in the fundraising process. Flat amount donations may be accommodated if donors prefer to not pledge against performance metrics. User engagement may be further enhanced by establishing a donor directory, where donors can receive recognition for their support and where others can view the details of their donations. User engagement may be further enhanced through real time tracking of donation generation information for entities that have produced performance metrics that have been pledged against, as well as the amount of donations raised by particular fundraisers. Such performance metric producing entities may include, but are not limited to sports leagues, sports teams, athletes, a stock market, an individual stock, a movie, or a political party. User engagement may be further enhanced by establishing a ranking system, where entities that produce performance metrics that are pledged against may be ranked according to the pledged donations they have generated. Such performance metric producing entities may include, but are not limited to, sports leagues, sports teams, athletes, a stock market, an individual stock, a movie, or a political party. User engagement may be further enhanced by providing external widgets that allow a user to display, in real time, donor donation amounts, donations raised by a fundraiser, or donations generated by entities that produce performance metrics that are pledged against. Such performance metric producing entities may include, but are not limited to, sports leagues, sports teams, athletes, a stock market, an individual stock, a movie, or a political party. Donors can view their historical and pending donations, run reports on this data, and generate tax forms for donations to qualifying charitable entities. Embodiments may provide a method for accurately and effectively validating fundraising entities that qualify as charitable organizations, and through this validation, charity and non-charity fundraisers can be clearly identified and labeled. Donations made via credit cards, debit cards, PayPal, and bank accounts can be accommodated, as well as direct payment via check or money order for donations that meet specific requirements.

In an aspect of inventive concepts, a method of facilitating pledges of monetary value between a pledgee and pledgor, the method including the steps of providing a graphical user interface having a plurality of selectable performance metrics and at least one input for a factor of monetary value, receiving a selected performance metric of the plurality of performance metrics and the at least one input for a factor of monetary value, transmitting and storing the received selected performance metric and the received input of a factor of monetary value to computer readable memory of a computer server system, periodically querying and obtaining a measured value of the selected performance metric and storing said measured value in the computer readable memory of the computer server system, and calculating a pledge amount of monetary value by applying said factor of monetary value to the measured value of the selected performance metric and storing the pledge amount of monetary value in the computer readable memory of the computer server system.

In an embodiment, the plurality of selectable performance metrics includes a statistic pertaining to athletic competition.

In an embodiment, the plurality of selectable performance metrics includes a statistic pertaining to a professional sports league. In an embodiment, the statistic pertaining to a professional sports league includes at least one statistic pertaining to the National Football League, Major League Baseball, National Hockey League, and National Basketball Association. In an embodiment, the statistic pertaining to a professional sports league includes at least one of games won, races won, touchdown passes scored, field goals scored, home runs hit, strike outs pitched, bases stolen, three point shots scored, free throws scored, birdies made, golf drives over 300 yards, knock outs during a fighting match, and submissions during a fighting or wrestling match.

In an embodiment, the plurality of selectable performance metrics includes a statistic pertaining to amateur or college athletics.

In an embodiment, the plurality of selectable performance metrics includes a statistic pertaining to activity of the stock market. In an embodiment, the statistic pertaining to activity of the stock market includes at least one of daily activity of the stock market, activity of individual stocks, and yearly activity of stock indices.

In an embodiment, the plurality of selectable performance metrics includes artistic entertainment. In an embodiment, the artistic entertainment includes at least one of a music concert, a music tour, a television show, activity of an actor over a given time period, and the opening weekend of a movie.

In an embodiment, the plurality of selectable performance metrics includes political activity. In an embodiment, the political activity includes at least one of an election, a debate, and a political fundraiser.

In an embodiment, the querying and obtaining a measured value includes querying and obtaining a measured value from a wide-area computer network. In an embodiment, the wide-area computer network is the Internet.

In an embodiment, the querying and obtaining a measured value includes querying and obtaining one or more secondary values different from the measured value and calculating the measured value from the one or more secondary values. In an embodiment, the measured value is at least one of the average and sum value of the secondary values.

In an embodiment, the method further includes determining at least one statistic of pledges in relation to one or more performance metrics. In an embodiment, the graphical user interface displays the at least one statistic. In an embodiment, the at least one statistic includes a rank based on the monetary value of pledges pertaining to one or more elements of one or more performance metrics. In an embodiment, the at least one statistic includes a sum of pledges made in relation to a team, player, or performer that is the performer of the performance metric.

In an embodiment, the statistic includes a sum of pledges made in relation to a particular pledgee and performance metric.

In an embodiment, the receiving a selected performance metric and the at least one input for a factor of monetary value further includes receiving a pledge term during which the selected performance metric was performed. In an embodiment, the pledge term includes a term of at least one of one or more individual games or events, one or more seasons, one or more playoffs of one or more seasons, and a career of a performer or competitor. In an embodiment, the receiving a pledge term includes receiving a term that is initially open-ended and wherein the open-ended term can later be ended by receiving input from an operator.

In an embodiment, the receiving a selected performance metric and the at least one input for a factor of monetary value includes receiving an information package of pledge attributes, the package of pledge attributes comprising a subject of the performance metric, the pledge term, the performance metric, and the factor of monetary value.

In an embodiment, the periodically querying and obtaining a measured value of the selected performance metric and storing said measured value in the computer readable memory is performed continuously during at least one interval of time.

In an embodiment, the periodically querying and obtaining a measured value of the selected performance metric includes querying and obtaining an intermediate status related to the performance metric.

In an embodiment, the intermediate status includes a status during an ongoing competition.

In an embodiment, the intermediate status includes at least one of leaders of an ongoing race or tournament and score of an ongoing game or match.

In an embodiment, the graphical user interface includes permitting an operator to perform the querying and obtaining of a measured value immediately in response to a command from the operator.

In an embodiment, the method further includes facilitating a payment of the pledge of monetary value from the pledgor to the pledgee. In an embodiment, facilitating payment includes collecting funds via at least one of a credit card account transaction, debit card account transaction, checking account transaction, money order, ACH transfer, wire transfer, and PayPal.

In an embodiment, providing a graphical user interface includes providing an application on a networked device and wherein the application incorporates the graphical user interface. In an embodiment, the networked device is a portable device. In an embodiment, the application is an Internet Web Browser. In an embodiment, the application is a widget.

In an embodiment, the networked device is programmed to operate as the computer server.

In an embodiment, the method further includes identifying the tax-exempt status of the pledgor.

In an embodiment, the method further includes generating a form for identifying a donation as a tax-deductible gift to a charitable organization.

In an aspect of inventive concepts, a system for facilitating pledges of monetary value between a pledgee and pledgor is provided, the system including at least one computer server having computer readable memory and a network interface, the at least one computer server programmed to facilitate display of a graphical user interface, the graphical user interface having at least one input with a plurality of selectable performance metrics and at least one input for a factor of monetary value. The computer server is further programmed to receive a selection of the selectable performance metrics and a factor of monetary value entered from the at least one input, store the selectable performance metrics and a factor of monetary value in the computer readable memory, receive a measured value of the selection of the selectable performance metrics and store said measured value in the computer-readable memory of the computer server, periodically query and obtain through the network interface a measured value of the selected performance metric and storing said measured value in the computer readable memory of the computer server, and calculate a pledge amount of monetary value by applying said factor of monetary value to said measured value of the selected performance metric and storing the pledge amount of monetary value in the computer readable memory of the computer server.

In an embodiment, the programming of the graphical user interface includes facilitating remote operation of the graphical user interface via the network interface. In an embodiment, the programming of the graphical user interface includes facilitating operation of the graphical user interface through an application installed on a networked device. In an embodiment, the application installed on a remote device is a Web Browser. In an embodiment, the networked device is a portable device. In an embodiment, the application installed on the networked device includes a widget. In an embodiment, the networked device is programmed to operate as the computer server.

In an embodiment, the plurality of selectable performance metrics includes a statistic pertaining to athletic competition. In an embodiment, the statistic pertaining to athletic competition includes a statistic pertaining to a professional sports league. In an embodiment, the statistic pertaining to a professional sports league includes at least one statistic pertaining to the National Football League, Major League Baseball, National Hockey League, and National Basketball Association. In an embodiment, the statistic pertaining to a professional sports league includes at least one of games won, races won, touchdown passes scored, field goals scored, home runs hit, strike outs pitched, bases stolen, three point shots scored, free throws scored, birdies made, golf drives over 300 yards, knock outs during a fighting match, and submissions during a fighting or wrestling match.

In an embodiment, the plurality of selectable performance metrics includes a statistic pertaining to activity of the stock market. In an embodiment, the statistic pertaining to activity of the stock market includes at least one of daily activity of the stock market, activity of individual stocks, and yearly activity of stock indices.

In an embodiment, the plurality of selectable performance metrics includes artistic entertainment. In an embodiment, the artistic entertainment includes at least one of a music concert, a music tour, a television show, activity of an actor over a given time period, and the opening weekend of a movie.

In an embodiment, the plurality of selectable performance metrics includes political activity. In an embodiment, the political activity includes at least one of an election, a debate, and a political fundraiser.

In an embodiment, the programming for querying and obtaining a measured value includes querying and obtaining a measured value from a wide-area computer network. In an embodiment, the wide-area computer network is the Internet.

In an embodiment, the programming for obtaining a measured value includes querying and obtaining one or more secondary values different from the measured value and calculating the measured value from the one or more secondary values. In an embodiment, the measured value is at least one of the average and sum value of the secondary values.

In an embodiment, the computer server is further programmed to determine at least one statistic of pledges in relation to one or more performance metrics. In an embodiment, the graphical user interface is programmed to display the at least one statistic.

In an embodiment, the at least one statistic includes a rank based on the monetary value of pledges pertaining to one or more elements of one or more performance metrics. In an embodiment, the at least one statistic includes a sum of pledges made in relation to a team, player, or performer that is the performer of the performance metric. In an embodiment, the statistic includes a sum of pledges made in relation to a particular pledgee and performance metric.

In an embodiment, the programming of the computer server to receive a selection of the selectable performance metrics and a factor of monetary value further includes programming to receive input of a pledge term during which the selected performance metric was performed.

In an embodiment, the pledge term includes a term of at least one of one or more individual games or events, one or more seasons, one or more playoffs of one or more seasons, and a career of a performer or competitor.

In an embodiment, the programming of the computer server to receive a pledge term includes programming to receive a term that is initially open-ended and wherein the programming provides an input for an operator to later end the open-ended term.

In an embodiment, the programming to receive at least one selection of the plurality of performance metrics and at least one input for a factor of monetary value includes programming to receive an information package of pledge attributes, the package of pledge attributes comprising a subject of the performance metric, the pledge term, the performance metric, and the factor of monetary value.

In an embodiment, the periodically querying and obtaining a measured value of the selected performance metric and storing said measured value in the computer readable memory is performed continuously during at least one interval of time.

In an embodiment, the computer server is programmed to query and obtain an intermediate status related to the performance metric. In an embodiment, the intermediate status includes a status during an ongoing competition. In an embodiment, the intermediate status includes at least one of leaders of an ongoing race or tournament and score of an ongoing game or match.

In an embodiment, the graphical user interface is programmed to permit an operator to perform the querying and obtaining of a measured value immediately in response to a command from the operator.

In an embodiment, the computer server is further programmed to facilitate payment of the pledge of monetary value from the pledgor to the pledgee.

In an embodiment, the facilitating payment includes collecting funds via at least one of a credit card account transaction, debit card account transaction, checking account transaction, money order, ACH transfer, wire transfer, and PayPal.

In an embodiment, the computer server is programmed to identify the tax-exempt status of the pledgor.

In an embodiment, the computer server is programmed to output a form for identifying a donation as a tax-deductible gift to a charitable organization.

In an embodiment, the computer server is programmed to maintain a directory of donors and their donations and to present data from the directory within the GUI.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same elements throughout the different views. The drawings are not necessarily to scale, emphasis instead being placed upon illustrating the principles of the inventive concepts in the drawings.

FIG. 1 is a high level block diagram of a fundraising process in accordance with an embodiment of the present inventive concepts.

FIG. 2 is a block diagram including an overview of how an Internet-based system functions according to an embodiment of present inventive concepts.

FIG. 3 is a block diagram illustrating processes and functions of a Donation Generating Engine according to an embodiment of present inventive concepts.

FIG. 4 is a block diagram illustrating processes and functions of a Donation Generating Engine according to a further embodiment of present inventive concepts.

FIG. 5 is a block diagram illustrating elements of a Donation Package unit according to an embodiment of present inventive concepts.

FIGS. 6-9. are screen shots of an interface for selecting and viewing donation parameters relating to performance metrics according to embodiments of present inventive concepts.

FIG. 10. is a screen shot of an interface for viewing and modifying selected pending donation parameters according to an embodiment of present inventive concepts.

FIG. 11. is a screen shot of an interface for finalizing donation parameters according to an embodiment of present inventive concepts.

FIG. 12 is a screen shot of an interface for tracking and managing donations relating to various performance metrics in accordance with an embodiment of present inventive concepts.

FIG. 13 is a screen shot of an interface for selecting and viewing an organization in which performance metrics are presented in real-time and can be selected for making donations in accordance with an embodiment of present inventive concepts.

FIG. 14 is a screen shot of an interface for selecting a sports league team in which performance metrics are presented in real-time and can be selected for making donations in accordance with an embodiment of present inventive concepts.

FIG. 15 is a screen shot of an interface for selecting a sports league player in which performance metrics can be selected for making donations in accordance with an embodiment of present inventive concepts.

FIG. 16 is a screen shot of an interface providing a real-time update of competitions between organizations in which performance metrics can be selected for making donations in accordance with an embodiment of present inventive concepts.

FIG. 17 is a screen shot of an interface providing a list of charities to which donations have been made in relation to a sports league in accordance with an embodiment of present inventive concepts.

FIG. 18 is a screen shot of an interface providing a list of donations made with respect to performers and performance metrics of a sports team in accordance with an embodiment of present inventive concepts.

FIG. 19 is a screen shot of an interface providing a summary of donations made with respect to the performance metrics of a performer in accordance with an embodiment of present inventive concepts.

FIG. 20 is a screen shot of an interface providing a summary of donations made with respect to an ongoing competition between performers in accordance with an embodiment of present inventive concepts.

FIG. 21 is a screen shot of an interface providing a ranking of donations made with respect to sports leagues, sports teams, and the players of the teams in accordance with an embodiment of present inventive concepts.

FIG. 22 is a screen shot of an interface providing a ranking of donations made by various individuals and businesses in accordance with an embodiment of present inventive concepts.

FIG. 23 is a screen shot of an interface providing virtual badges including donation amounts with respect to donors or with respect to performers of performance metrics in accordance with an embodiment of present inventive concepts.

FIG. 24 is a high level block diagram illustrating data and process flow within a system for facilitating donations in accordance with an embodiment of present inventive concepts.

FIG. 25 is a high level block diagram illustrating process flow within a system for facilitating donations in accordance with an embodiment of present inventive concepts.

### DETAILED DESCRIPTION

The foregoing and other objects, features and advantages of the embodiments of the invention will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept in the drawings.

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

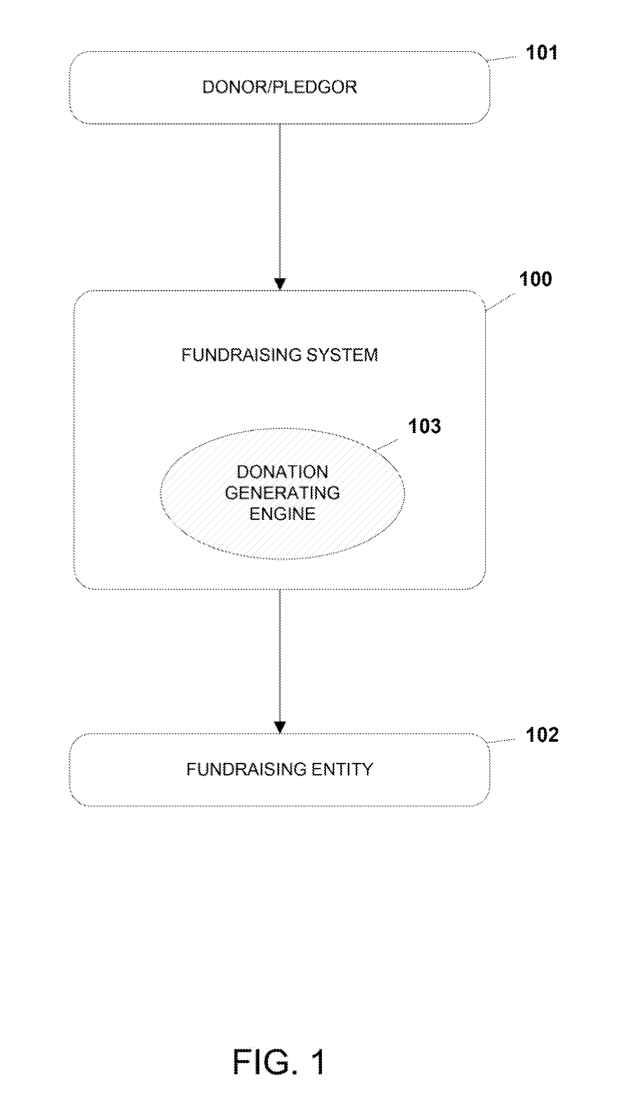

Methods and systems for fundraising are provided in aspects of present inventive concepts. FIG. 1 is a high level block diagram of a fundraising process in accordance with an embodiment of present inventive concepts. The process is built around three core elements: a Donor/Pledgor 101, a Fundraising System 100, and a Fundraising Entity 102. The Donor/Pledgor 101 can pledge and donate to the Fundraising Entity 102. The Donor/Pledgor 101 can be represented as an individual, a group or club, a for-profit organization, a non-profit organization, or any other entity that is able to distribute donations. The Fundraising Entity 102 can be represented as an individual, group or club, a for-profit organization, a non-profit organization, or any other entity that is able to receive donations. In the event a Fundraising Entity 102 is a qualifying charity, donations received by such entities may qualify as tax-exempt charitable donations. In an embodiment, a validation process can be implemented for a Fundraising Entity 102 to be classified as a valid charitable organization and receive the benefit of tax-exempt donations.

The Fundraising System 100 can operate as the inter-agent, between the Donor/Pledgor 101 and Fundraising Entity 102. The Fundraising System 100 may be responsible for providing the interface through which the Donor/Pledgor 101 interacts, the interface through which the Fundraising Entity 102 interacts and makes itself available to the Donor/Pledgor 101, the method through which donations are pledged and generated (Donation Generating Engine 103), the collection and processing of the donations, the secure storage of all collected information related to the fundraising process, the disbursement of funds to the Fundraising Entity 102, and all fundraising related reporting.

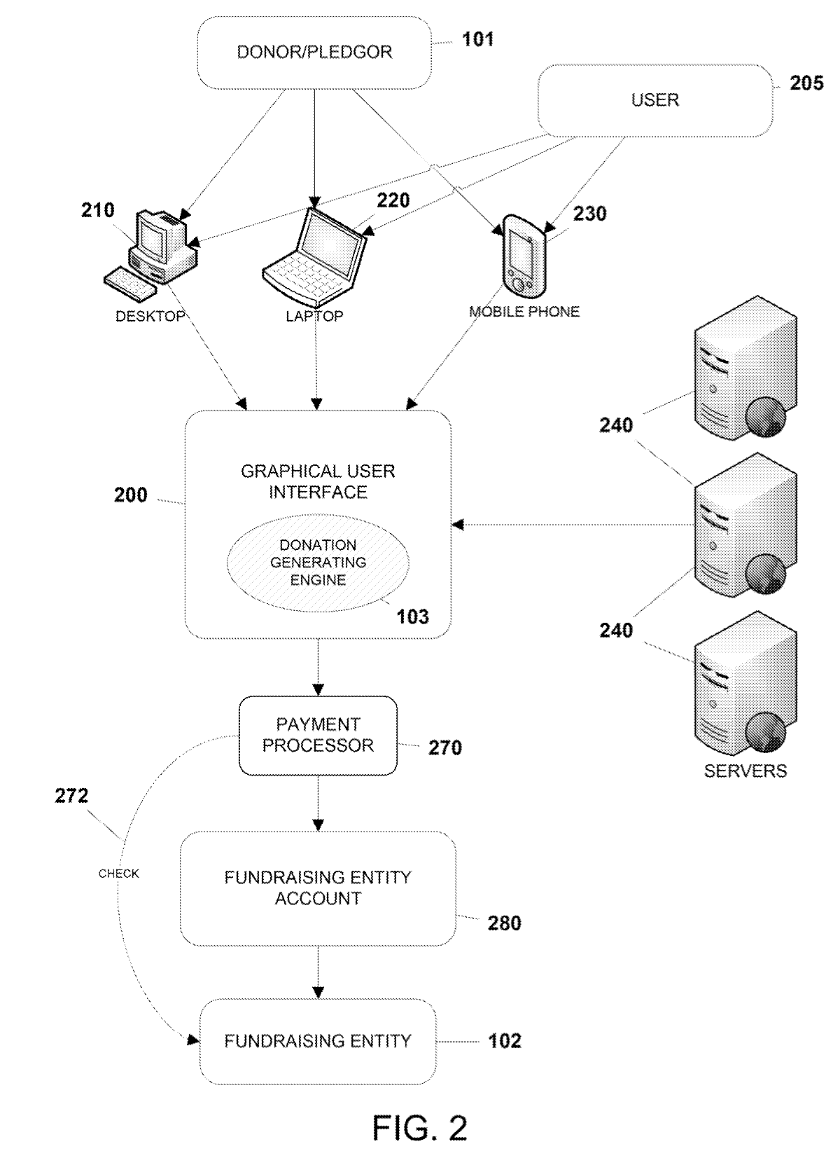

In an embodiment, the Fundraising System 100 is accessible via the Internet such as through a Web-browsable website. FIG. 2 is a block diagram including an overview of how an Internet-based system functions according to an embodiment of present inventive concepts. FIG. 2 depicts an overview of how the Internet-based system functions. The fundraising process can be driven by Donor/Pledgor 101 interaction with the GUI 200 comprising a software application that will be hosted on one or more Servers 240. A Server 240 can comprise any computer system hosting a computer program and/or website that is accessible via a wide area network such as, for example, the Internet. Donors/Pledgors 101 can access GUI 200 using a network capable device, including but not limited to Desktop Computers 210, Laptop Computers 220, and Mobile Phones 230. After donations are pledged and confirmed, funds may be collected from the Donors/Pledgors 101 and processed by a Payment Processor 270. These funds may be collected using a variety of different methods including but not limited to credit card, debit card, check, money order, ACH transfer, wire transfer, or PayPal. The role of Payment Processor 270 may be taken on by any entity that qualifies to handle the collection and distribution of monies generated through fundraising activities and such entities may include, but are not limited to, banks, other financial institutions, and other third party organizations that offer such services. Once donation funds are processed and confirmed, they can be transferred into a Fundraising Entity Account 280 via ACH transfer, wire transfer, or other secure method suitable for such a transaction. Alternatively, funds may be transferred into a qualified Escrow account before being transferred into a Fundraising Entity Account 280. Another alternative scenario involves payment being directly made to the Fundraising Entity 102 via check as depicted by a dotted line 272 connecting the Payment Processor 270 to the Fundraising Entity 102. If transaction fees are collected, these fees may be collected before disbursement to the Fundraising Entity Account 280 or Fundraising Entity 102, or they may be paid by the Fundraising Entity 102 after funds are received. Hereafter, the term Fundraising Entity 102 will be used to represent both the Fundraising Entity Account 280 and the Fundraising Entity 102 itself when referring to an entity that receives funds from donations. In circumstances where a distinction is required, it will be made.

In an Internet-based embodiment, an entity known as a User 205 also has access to a GUI 200 that can operate as a website interface. In an embodiment, A User 205 may be any entity that accesses the GUI 200 but does not necessarily make a donation. They can access certain reports and lists that the GUI 200 provides and interact with certain features of the GUI 200, but may be limited in access to various features accessible as a Donor/Pledgor 101. In an embodiment, a User 205 may have administrative privileges that allow the User 205 to monitor donor/pledgor/fundraiser activity, add/remove/change fundraising entities and/or performance metrics or other functions of Server(s) 240.

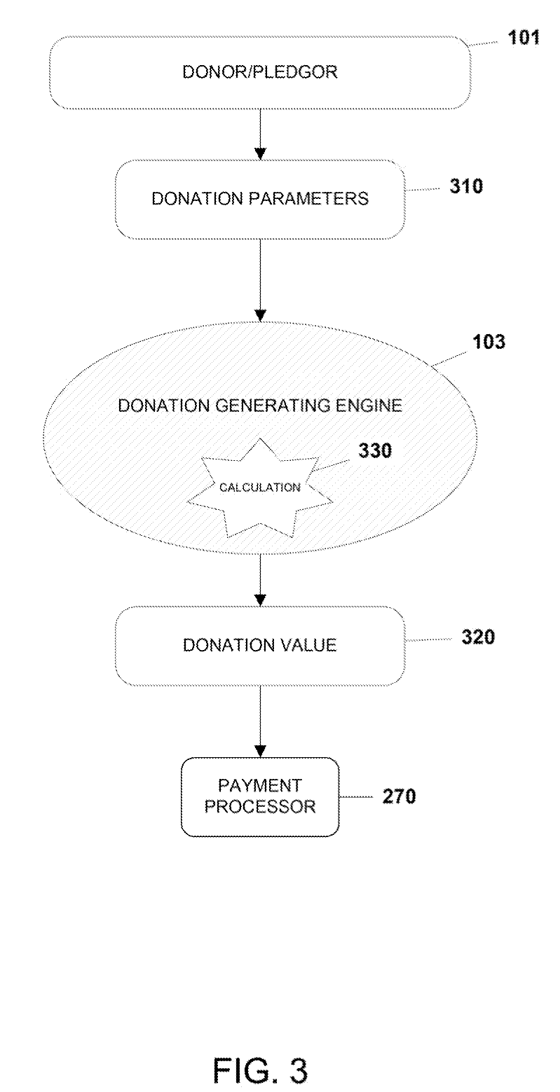

FIG. 3 is a block diagram illustrating processes and functions of a Donation Generating Engine 103 according to an embodiment of present inventive concepts. The Donation Generating Engine 103 is a component of the Fundraiser System 100 (e.g., of FIG. 2) and provides a method and technique by which the amount of donations pledged is generated. In an embodiment of a fundraiser system on the Internet as depicted in FIG. 2, the Donation Generating Engine 103 is driven by the computer program that supports a GUI 200. In an embodiment, the process can begin with a Donor/Pledgor 101 defining Donation/Pledge Parameters 310, which is the input used by the technique the Donation Generating Engine 103 utilizes. The input is received by the Donation Generating Engine 103 and according to its methodology executes a Calculation 330 with that input. The Calculation 330 performed can vary and may be dependent on the nature of the input supplied. The end result of the Calculation 330 comprises the Donation Value 320, which is the monetary amount that is actually being donated. That Donation Value 320 may be then fed to the Payment Processor 270, which handles donation collection and payment processing.

Embodiments of the Donation Generating Engine 103 can range in sophistication. An example of a basic Donation Generating Engine 103 is one where the donation is a flat amount chosen by the Donor/Pledgor 101. In this example, the Donation Parameters 310 would be comprised of the amount the Donor/Pledgor 101 has chosen to donate. The Calculation 330 is a one-to-one conversion, and it produces a Donation Value 320 that is equivalent to the supplied Donation Parameters 310.

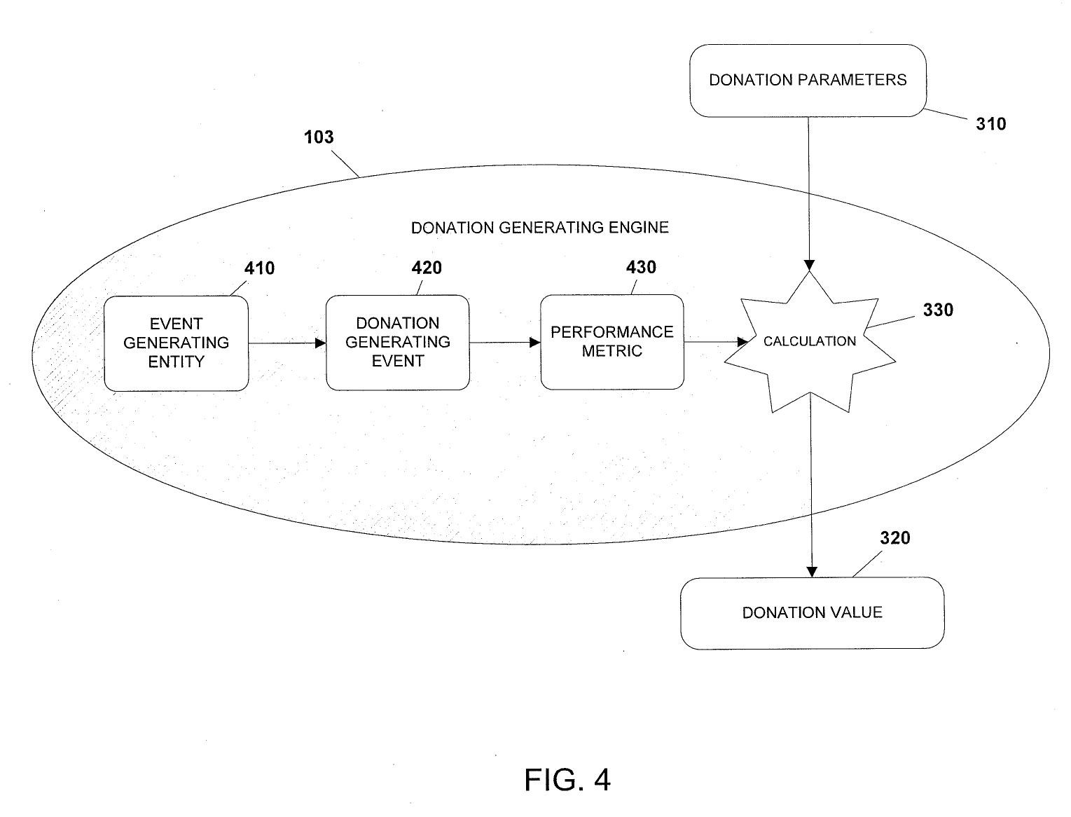

FIG. 4 is a block diagram illustrating processes and functions of a Donation Generating Engine 103 according to a further embodiment of present inventive concepts. An embodiment of a more complex Donation Generating Engine 103 includes determining a donation amount in relations to a pledge against a particular performance metric arising from an event that produces metrics that are definable and measurable and, in a further embodiment, verifiable. This may be referred to herein as a performance-based donation model. The diagram in FIG. 4 illustrates such an example. Here, the Donation Generating Engine 103 can be driven by an Event Generating Entity 410 (including, for example, a person or organization) that can produce a Donation Generating Event 420 (including, for example, a measurable performance). From that event, a Performance Metric 430 can be derived and fed into the Calculation 330. The Calculation 330 can then be performed using that Performance Metric 430 in combination with the supplied Donation Parameters 310. The result is the Donation Value 320. When a Donation Generating Event 420 produces many Performance Metrics 430, the Calculation 330 may be performed multiple times, and each time it is executed, the resulting Performance Metric 430 can be passed to the Calculation 330, and the result may be added to the Donation Value 320. In various embodiments, the Donation Value 320 can continue to grow with each passed result until one or more concluding events occur, including, for example: the term of the Donation Generating Event 420 ends; the Donor/Pledgor 101 specified maximum value is reached; or the Donor/Pledgor 101 manually ends the donation. Whichever the method, referring to FIG. 3, the finalized Donation Value 320 may be passed to the Payment Processor 270 for collection.

In certain embodiments, in order to qualify as an Event Generating Entity 410, the entity in question produces a qualified Donation Generating Event 420. A qualified Donation Generating Event 420 can be one that produces Performance Metrics 430 that are definable and, in further embodiments, measurable, and verifiable. Examples of an Event Generating Entity 410 may include, but are not limited to, professional sports leagues, professional sports teams, professional athletes, collegiate sports leagues/divisions, collegiate sports teams, collegiate athletes, local sports leagues, local sports teams, local athletes, Olympic teams, Olympic athletes, the stock market, individual stocks, stock portfolios, stock indices, bands/performers, actors, movie studios, award ceremonies, politicians, political parties, websites, and fundraising entities themselves.

Using the example of a professional athlete, a donation scenario according to an embodiment can play out as follows. Assume there is a professional baseball player by the name of John Smith. Referring to FIGS. 3 and 4, a Donor/Pledgor 101 can select to use John Smith as an Event Generating Entity 410, because John Smith participates in games that qualify as Donation Generating Events 420. In an embodiment, those games qualify as Donation Generating Events 420 because from those games arise Performance Metrics 430 related to John Smith that are definable, measurable, and verifiable. For instance, these Performance Metrics 430 could include, but are not limited to, “base hits”, “homeruns”, “RBIs”, or “stolen bases”. If the Donor/Pledgor 101 provided Donation Parameters 310 that stated they would donate $10.00 each time John Smith hit a homerun in the game on Saturday night, these would be fed into the Calculation 330 and each time a Performance Metric 430 was supplied that matched up with the Donation Parameters 310, the Calculation 330 can be executed with the result being added to the Donation Value 320. In this example, each time a homerun was hit, the 1 homerun would be multiplied by $10.00. After 2 homeruns, the calculation would have been performed two times and the Donation Value 320 would stand at $20.00 ($10.00×1 homerun×2 times). If the Donor/Pledgor 101 never specified a maximum and did not choose to end the donation, this calculation would continue until the end of the Donation Generating Event 420, which was defined as the game on Saturday night. If John Smith hit 4 homeruns during the game, then the final Donation Value 320 would be $40.00 and be passed to the Payment Processor 270 for collection via any of the accepted payment methods.

Various embodiments of present inventive concepts can make use of this performance-based donation model through a Donation Generating Engine 103. By using a model that derives its donations through Performance Metrics 430, user participation and interaction can increase, which in turn, can increase user engagement. In these embodiments, it is delivered through the Internet so as to improve automation and provide a framework that supports interactivity/engagement. In these embodiments, Event Generating Entities 410 can be comprised of sports leagues, teams, and athletes at the professional, collegiate, local, and Olympic level. Utilizing sport related entities that already attract significant interest from a large audience may further enhance the value of the performance based donation model and continue to drive user engagement to new levels. The end result is a system and method that can provide a motivation to contribute that extends far beyond the core desire to donate.

In some embodiments, the Fundraising Entity 102 can register as either a charity or a non-charity organization. In the event it is a qualified charity (which can, in an embodiment, require validation), donations made via the Fundraising System 100 to such an entity may be tax-deductible. The Fundraising System 100 can also provide tax-reporting to a Donor/Pledgor 101 for all charitable donations. In an embodiment, the Fundraising System can verify a fundraising entity's tax-exempt status (e.g., through the IRS' online verification systems) for proper tax-related categorizing of completed and pending tax-deductible donations. In an embodiment, the Fundraising System can generate a printable form or receipt for identifying the donation as a tax-deductible donation.

In an embodiment, once registered in the Fundraising System 100 which is comprised of a Graphical User Interface 200, a Fundraising Entity 102 can immediately begin receiving flat amount donations. In order to utilize the performance based Donation Generating Engine 103, the Fundraising Entity 102 can choose one or more Event Generating Entities 410 they want to use to drive their fundraising effort. For instance, a large charity can use the National Football League (and thus all the teams and players in it). A local little league team can use itself or the local professional team. A college can use their own football team in combination with a professional league. In effect, any Fundraising Entity can utilize any qualifying Event Generating Entity 410 to drive their fundraising efforts. Once an Event Generating Entity 410 is selected, Donor/Pledgors are able to begin pledging donation amounts against selected Performance Metrics 430 that arise out of selected Donation Generating Events 420.

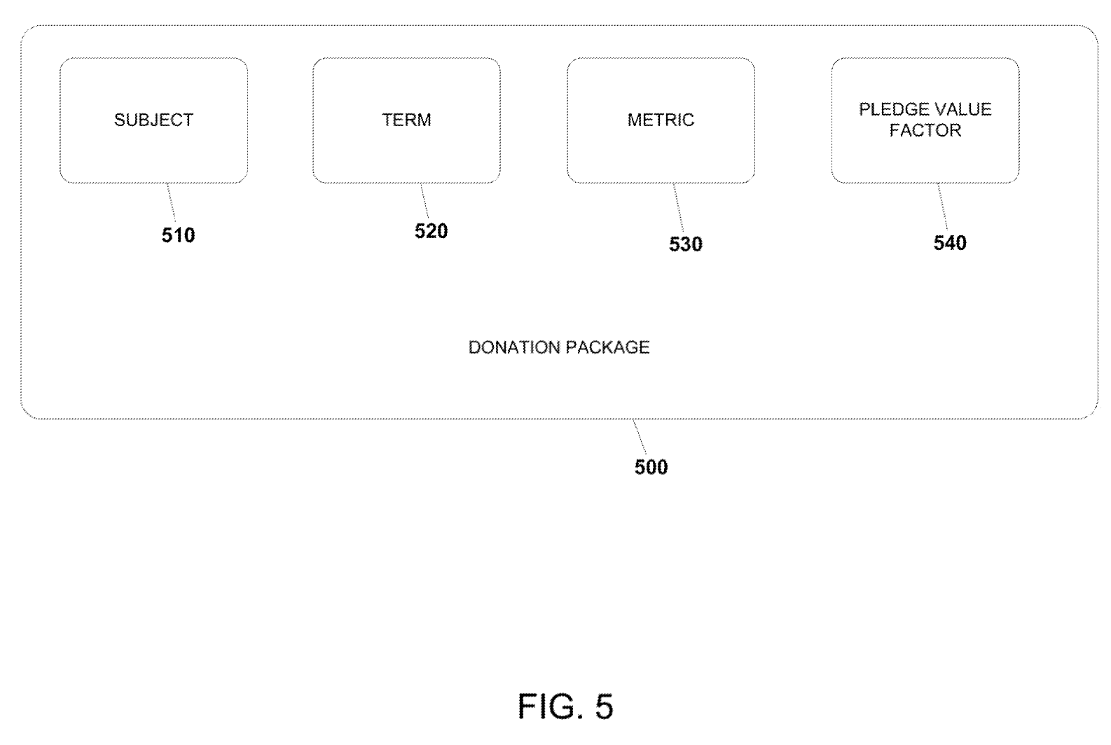

FIG. 5 is a block diagram illustrating elements of a Donation Package unit 500 according to an embodiment of present inventive concepts. In certain embodiments, donations can be created and pledged by Donors/Pledgors using a Donation Package 500 unit. The Donation Package 500 simplifies the donation process for Donors/Pledgors by presenting a methodology for collecting Donation Parameters that can be concise, easy to understand, and packageable. In various embodiments, the elements of the Donation Package 500 can include a Subject 510, a Term 520, a Metric 530, and a Pledge Value Factor 540. Effectively these can define the Donation Parameters 310 that can be provided to the Donation Generating Engine 103 (of FIGS. 3 and 4). From that, the actual Donation Value 320 can be calculated. The Subject 510 can comprise the Event Generating Entity 410 that the Donor/Pledgor wants to pledge with respect to. In a sports driven embodiment, this may include but is not limited to any particular sport league, team, or athlete. In an embodiment, the Donation Generating Event 420 can comprise a Term 520 chosen by the Donor/pledgor 101 that is supported by the Subject 510. In a sports driven embodiment, this could include, but is not limited to, a single game or event, an entire season, the playoffs of a particular season, or be open-ended (requiring manual stoppage by the Donor/Pledgor). The Metric 530 can comprise the specific Performance Metric 430 that is pledged against, which may be generated by the selected Subject 510 and performed during a selected Term 520. Any measurable Performance Metric 430 that is relevant to the Event Generating Entity 410 and the Donation Generating Event 420 qualifies as a possible Metric 530. A Metric 430 may include, but is not limited to the following examples: games won, races one, touchdown passes scored, field goals scored, home runs hit, strike outs, stolen bases, three pointers made, free throws made, birdies made, drives over 300 yards, TKOs, and submissions. The final element of the Donation Package 500 is the Pledge Value Factor 540 which can comprise the monetary amount the Donor/Pledgor 101 pledges to donate each time the Metric 530 is achieved. Put alternatively, whenever the Subject 510 generates the chosen Metric 530 during the span of the Term 520, the Donor/Pledgor 101 pledges to donate an amount equal to the Pledge Value Factor 540 applied to the chosen Metric 530. Once the Donation Package 500 has been completed and confirmed by the Donor/Pledgor 101, it becomes active and can begin generating donations. In an embodiment, the Pledge Value Factor 540 is not necessarily a unit of currency, but anything deemed of value.

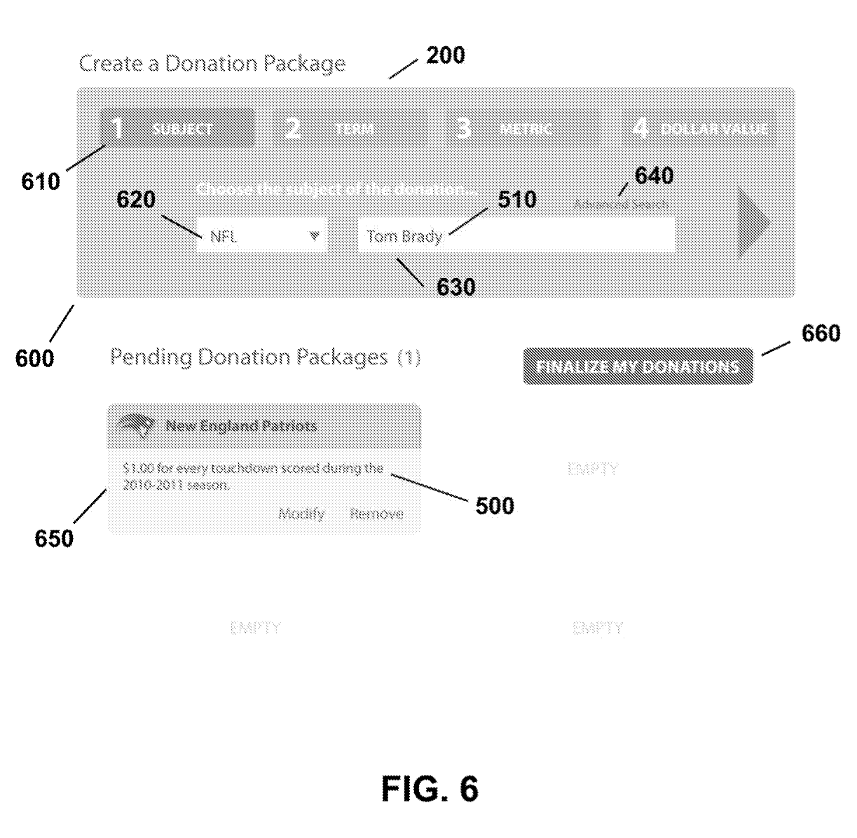

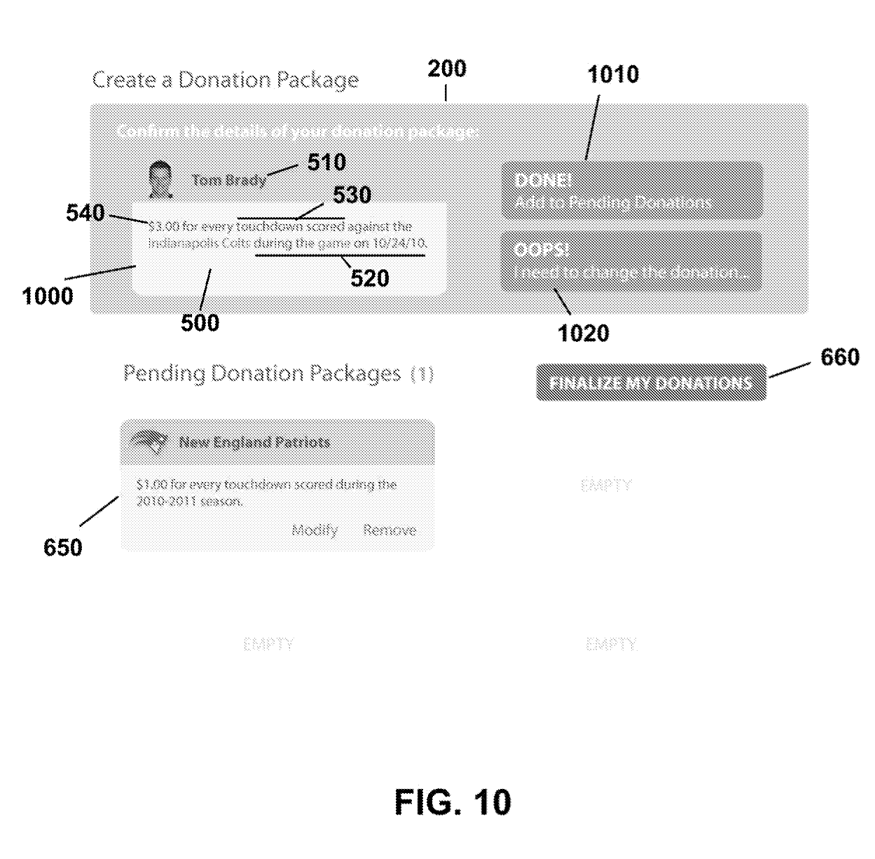

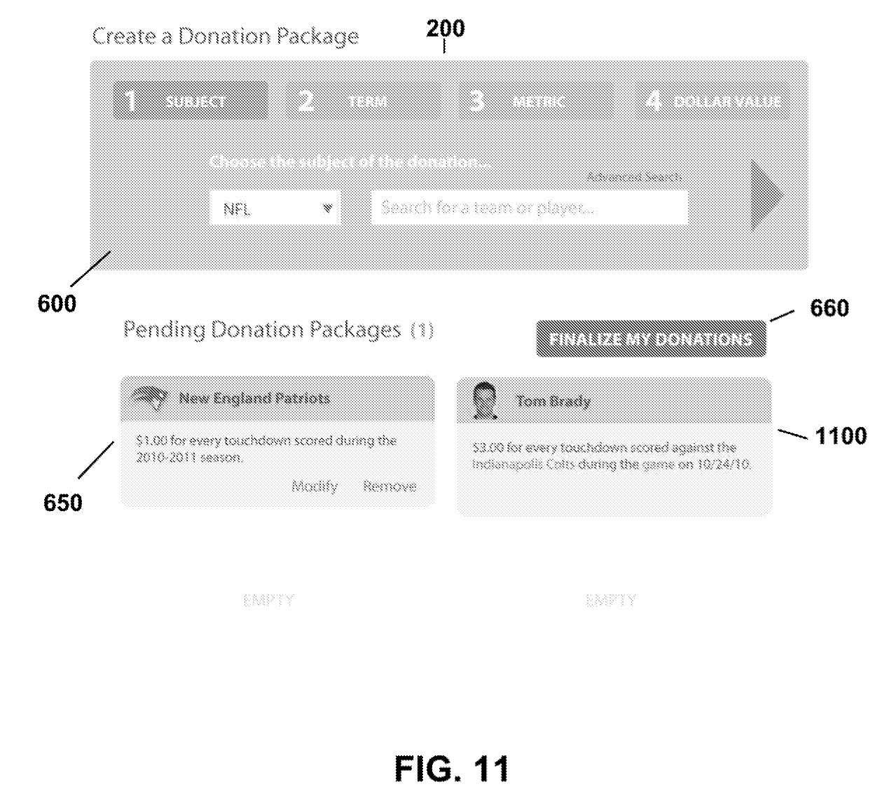

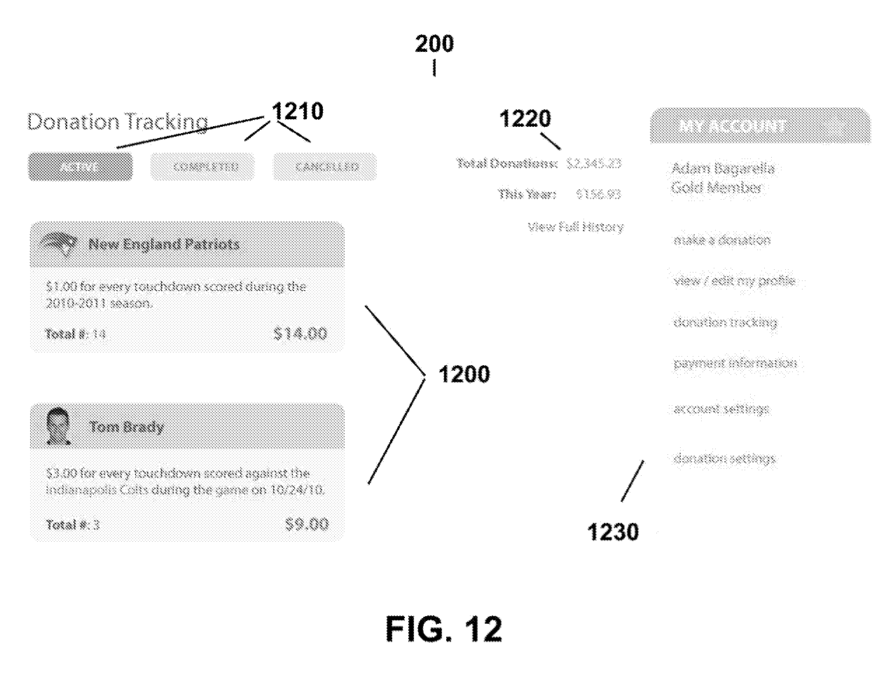

FIGS. 6-9. are screen shots of an interface for selecting and viewing donation parameters relating to performance metrics according to embodiments of present inventive concepts. FIG. 10 is a screen shot of an interface for viewing and modifying selected pending donation parameters according to an embodiment of present inventive concepts. FIG. 11 is a screen shot of an interface for finalizing donation parameters according to an embodiment of present inventive concepts. FIG. 12 is a screen shot of an interface for tracking and managing donations relating to various performance metrics in accordance with an embodiment of present inventive concepts.

FIGS. 6-12 further illustrate an embodiment of the Donation Package creation process through, for example, a GUI 200 used for creating or modifying a Donation Package 500. FIG. 6 depicts a Create Donation Package Dialog Box 600, facilitating the first step of the process, which is choosing the Subject 510 with a Subject Button 610. Subject Button 610 is uniquely marked (e.g., highlighted), which tells a Donor/Pledgor that is the current step they are on. The Donor/Pledgor is prompted to choose a Subject 510. They are presented with a League Drop Down List 620 that allows them to choose the league they would like. While the National Football League (NFL) is selected in the present illustrative embodiment, this could be any qualifying sports league which includes, but is not limited to, the National Basketball Association (NBA), National Hockey League (NHL), Major League Baseball (MLB), Professional Golfers Association (PGA), National Association for Stock Car Auto Racing (NASCAR), and any local sports league. In the Team/Athlete Text Box 630 a Donor/Pledgor can select which team or athlete that belongs to the selected league they would like to pledge against. This team or athlete will serve as the Subject of the Donation Package 500. In certain embodiments, the Donor/Pledgor can choose to perform a more advanced search for a Team or Athlete by selecting the Subject Advanced Search Link 640. While Tom Brady is selected, this can be any team or player in the selected league, for example: Adam Vinatieri, the Minnesota Vikings, or Randy Moss. The Pending Donation Package 650 represents another Donation Package 500 that was already completed and may be pending finalization. If the Donor/Pledgor wanted to finalize a Donation Package 500 listed as pending, they can choose to select the Finalize My Donations button 660.

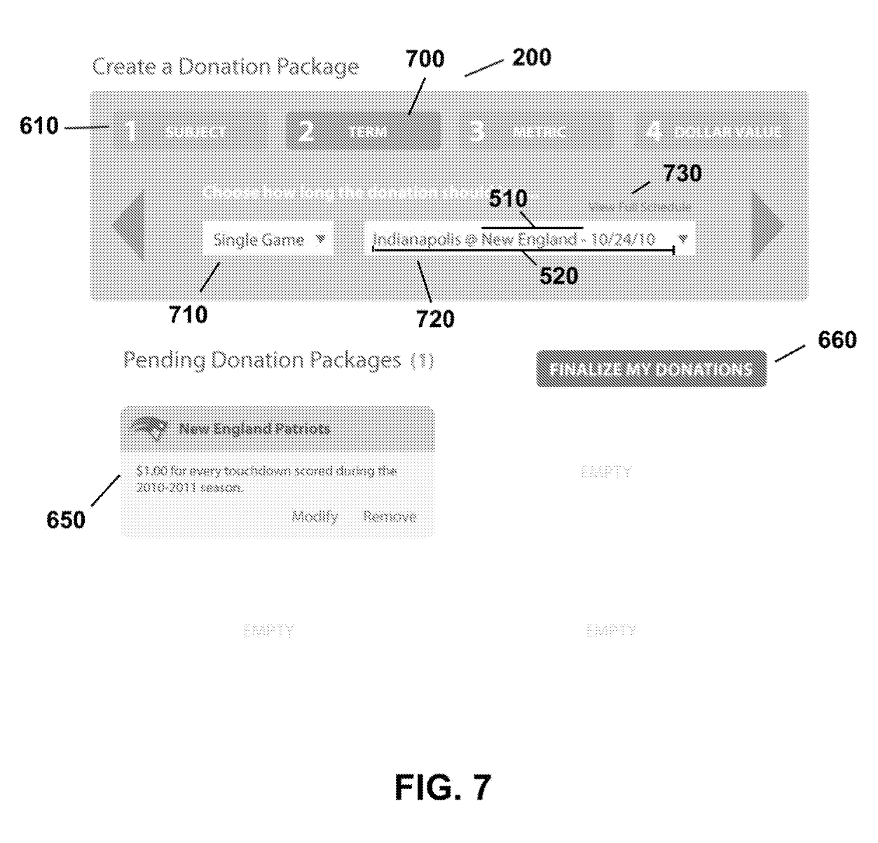

FIG. 7 depicts a second step of a Donation Package 500 creation process in accordance with an illustrative embodiment. In this step a Term Button 700 is uniquely identified (e.g., highlighted), informing the Donor/Pledgor they are on the second step of the process. The Donor/Pledgor is prompted to select a Term 520. An Event Type Dropdown List 710 allows a user to select what type of event they would like. A drop-down list 720 can be where the Donor/Pledgor specifies the exact event they would like to use in connection with the Term 520. A single game against a single team is shown selected, but this event could be any Donation Generating Event 420 that is generated by the chosen Subject 510. Examples include: an entire season or a playoff series. In certain embodiments, a View Full Schedule Link 730 allows the Donor/Pledgor 101 to perform a more in-depth search to find an event that will define the Term 520.

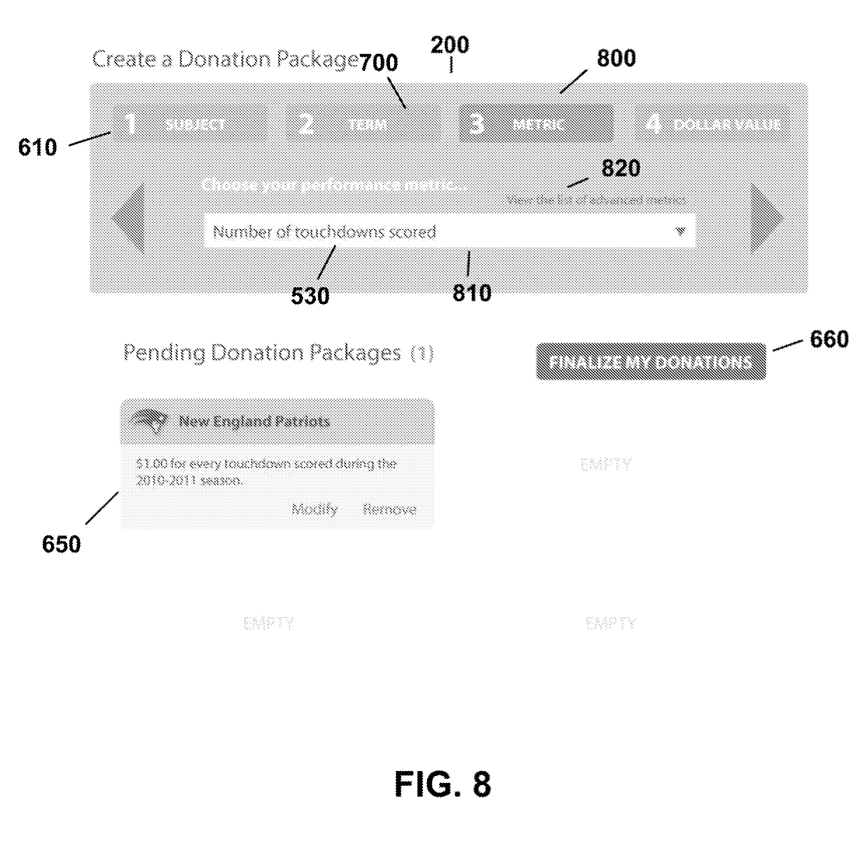

FIG. 8 depicts a third step of a Donation Package 500 creation process in accordance with an illustrative embodiment. In this step, the Metric Button 800 is highlighted, informing the Donor/Pledgor they are on the third step of the process. The Donor/Pledgor 101 is prompted to select a Metric 530. The Metric Drop Down List 810 provides the Donor/Pledgor 101 with a list of the commonly chosen Metrics 530 associated with the Subject 510 and Term 520 they have selected. Although “number of touchdowns scored” is selected, other possible Metrics 530 may include, but are not limited to “touchdown passes thrown”, “passes completed”, “extra points made”, or “completed passes over 30 yards”. In some embodiments, the View Advanced Metrics Link 820 allows the Donor/Pledgor to search for more Metrics 530 than the Metric Drop Down List 810 provides them. The Metric 530 could be any measureable performance metric corresponding to the chosen Subject 510 (of FIG. 6) during the chosen Term 520 (of FIG. 7).

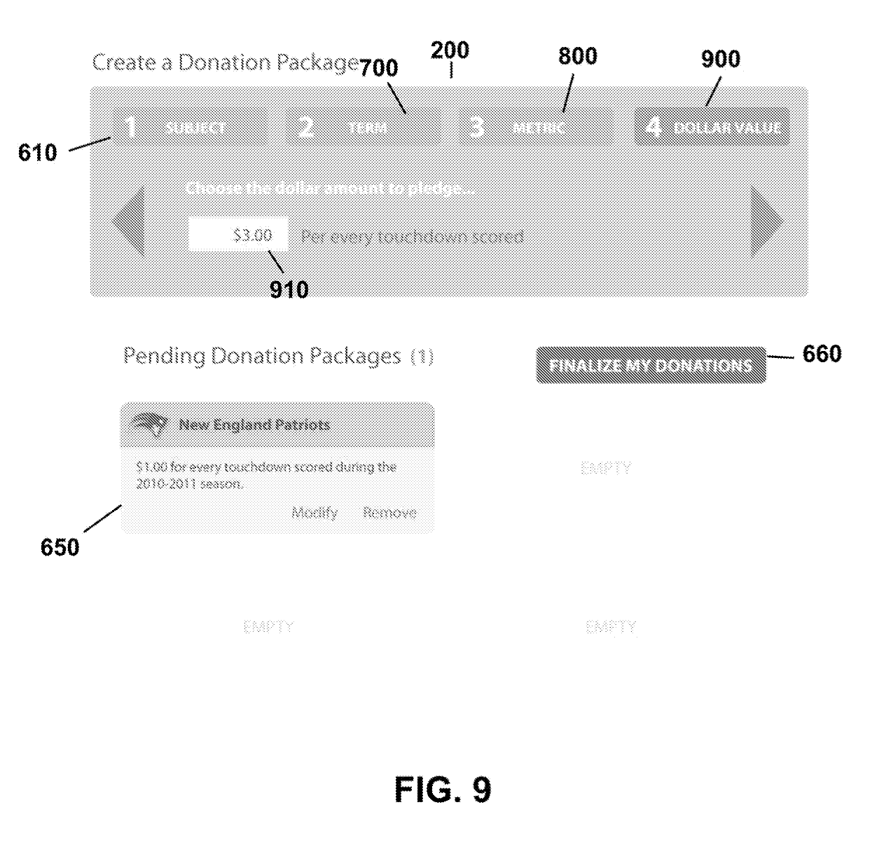

FIG. 9 depicts a final step of the Donation Package 500 creation process according to an illustrative embodiment. In this step the Pledge Value Button 900 is highlighted, informing the Donor/Pledgor they are on the fourth and final step of the process. The Donor/Pledgor is prompted to enter the Pledge Value Factor 540 in a Pledge Value Text Box 910. The Pledge Value Text Box 910 allows the Donor/Pledgor 101 to enter in the Pledge Value Factor 540 they would like to pledge each time the Metric 530 (of FIG. 8) is satisfied. Any monetary amount can be entered into this field, such as $0.10, $1.00, £5.00, or [symbol] 100 or, in an embodiment, any unit of measureable value

FIG. 10 depicts a confirmation step of the Donation Package 500 creation process according to an embodient. Here, the Donor/Pledgor is presented with a Donation Package Summary Box 1000 for the Donation Package 500 they have just created. If the details are correct, the Donor/Pledgor can confirm the Donation Package 500 by selecting a Done Button 1010. If they want to modify the details of the Donation Package 500 they can select an “Oops!” Button 1020. If this is clicked, they will be brought back through the previous steps (of FIGS. 6-9) to modify the Subject 510, Term 520, Metric 530, or Pledge Value Factor 540.

In accordance with an embodiment, FIG. 11 depicts the Donation Package 500 that was confirmed in FIG. 10, listed as a Pending Donation Package 1100, along with the original Pending Donation Package 650 that was previously presented. At this point, the Donor/Pledgor can create another Donation Package 500 by repeating the same steps through the Create a Donation Package Dialog Box 600, or if they want to finalize their Pending Donation Packages 650/1100, they can do that by selecting the Finalize Donations Button 660.

Referring back to FIG. 4, one or more resulting Donation Packages 500 can then be passed into the Donation Generating Engine 103 and into the Calculation 330 as the Donation Parameters 310. Assuming a Donation Package 500 matches up with the Performance Metrics 430 arising from the Donation Generating Event 420 driven by the Event Generating Entity 410, the Donation Value 320 will continue to increase unless a pre-selected maximum is reached, the Donor/Pledgor chooses to end the donation, or the term 520 of the pending donation reaches its conclusion. Once the final Donation Value 320 is determined, it can be passed to the Payment Processor 270 (of FIG. 3) for collection. In some embodiments, the Donor/Pledgor can opt to supply the payment method and information before the final Donation Value 320 is calculated, in which case when the final Donation Value 320 is confirmed, the Donor/Pledgor may be automatically charged via their chosen payment method. Alternatively, the Donor/Pledgor can choose to wait until the final Donation Value 320 is confirmed to provide payment information and complete the donation. In either case, the donation may not be considered collected until payment is processed and confirmed.

In certain embodiments, once Donation Packages are confirmed, they are listed as active. Donors/Pledgors are able to track the status of these Donation Packages as well as view Donation Packages that are completed (have been collected), and ones that have been cancelled (not collected). FIG. 12 depicts a donation tracking page for Donors/Pledgors. The Donation Type Buttons 1210 allow a Donor/Pledgor to choose which types of Donation Packages they would like to view: active, completed, or cancelled. The Donation Package List 1200 displays the Donation Packages that fall under the type that is currently selected. In the current depiction, active donation packages are listed. The Donor Donation Summary 1220 gives a brief breakdown of the completed donations of the Donor/Pledgor for certain segments of time, which, for example, can include: for all time and for the current year.

To encourage repeat donations and foster Donor/Pledgor retention, in certain embodiments, Donor/Pledgor's personal information and payment information can be electronically stored by the Fundraiser System 100. A Donor/Pledgor can use the stored payment information for any future donations and will not be required to re-enter any personal information. They will have the option of editing this information if any of it has changed. An Account Sidebar 1230 in FIG. 12 allows the Donor/Pledgor to perform such tasks. They can make another donation, view/edit their stored profile/personal information, view/edit their stored payment information, and perform a host of other account related tasks.

In certain embodiments, user engagement may be further enhanced by supporting real time tracking of fundraising and donation information. Users are able to view real time donation totals per a fundraising entity 102, an Event Generating Entity 410, or a Donation Generating Event 420. For a sports driven embodiment, for example, such Event Generating Entities 410 may include, but are not limited to, sports leagues, sports teams, and athletes. Donation Generating Events 420 may include, but are not limited to, single games, entire seasons, and particular series. Certain Event Generating Entities 410, such as professional sports, support automated and electronic data feeds, which supply Performance Metric 430 information directly to the Fundraiser System 100 requiring no manual input. The real time nature of this data may be dependent on the integrity of the data feed supplying the information. For other Event Generating Entities 410, such as local sports teams, Performance Metric 430 data can be manually supplied. The real time nature of this data may be dependent on the timeliness of the input. In either scenario, donation information in the Fundraiser System 100 can be updated in real time as soon as it is received, and is immediately viewable through an interface, such as the GUI 200.

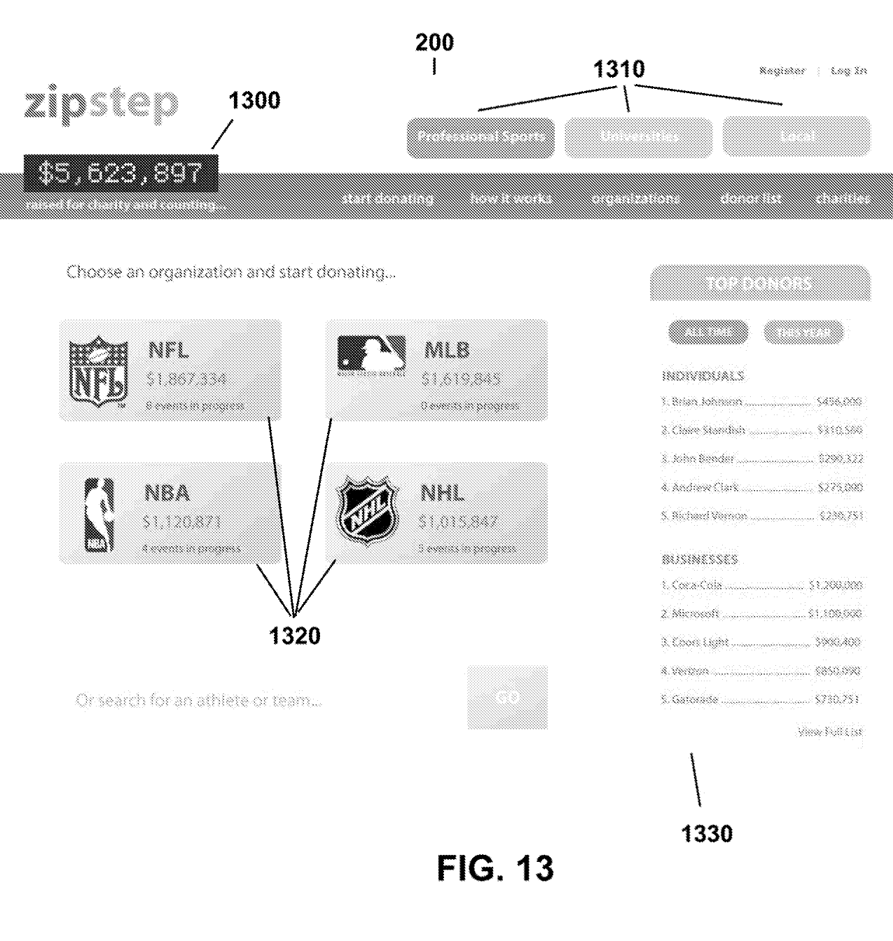

FIGS. 13-20 illustrate examples of this real time information tracking through a GUI 200. While these embodiments focus on professional sports and specifically the NFL, any measureable performance of an Event Generating Entity can be used, including but not limited to, any other professional, collegiate, and local sports leagues, teams, and athletes.

FIG. 13 is a screen shot of an interface for selecting and viewing an organization in which performance metrics are presented in real-time and can be selected for making donations in accordance with an embodiment of present inventive concepts. FIG. 13, in particular, depicts a fundraising system home page relating to professional sports. In an embodiment, a System-Wide Donation Counter 1300 displays the total amount of donations collected for all time by a fundraising system. Several “Site” buttons 1310 allow operators to navigate to the different sections within the system pertaining to different types of Event Generating Entities. In this embodiment they include Professional Sports, University (College) Sports, and Local Sports, but these could be any number of categories that contain Event Generating Entities. A League Listings Selector 1320 displays professional leagues that are being used as Event Generating Entities and the amount of donations they have generated for all-time in the system. Again, this League Listing Selector 1320 could include any sports league or other organization representing other Event Generating Entities. A Top Donors List 1330 provides a listing of the top individual and business donors ranked by donation amount system-wide.

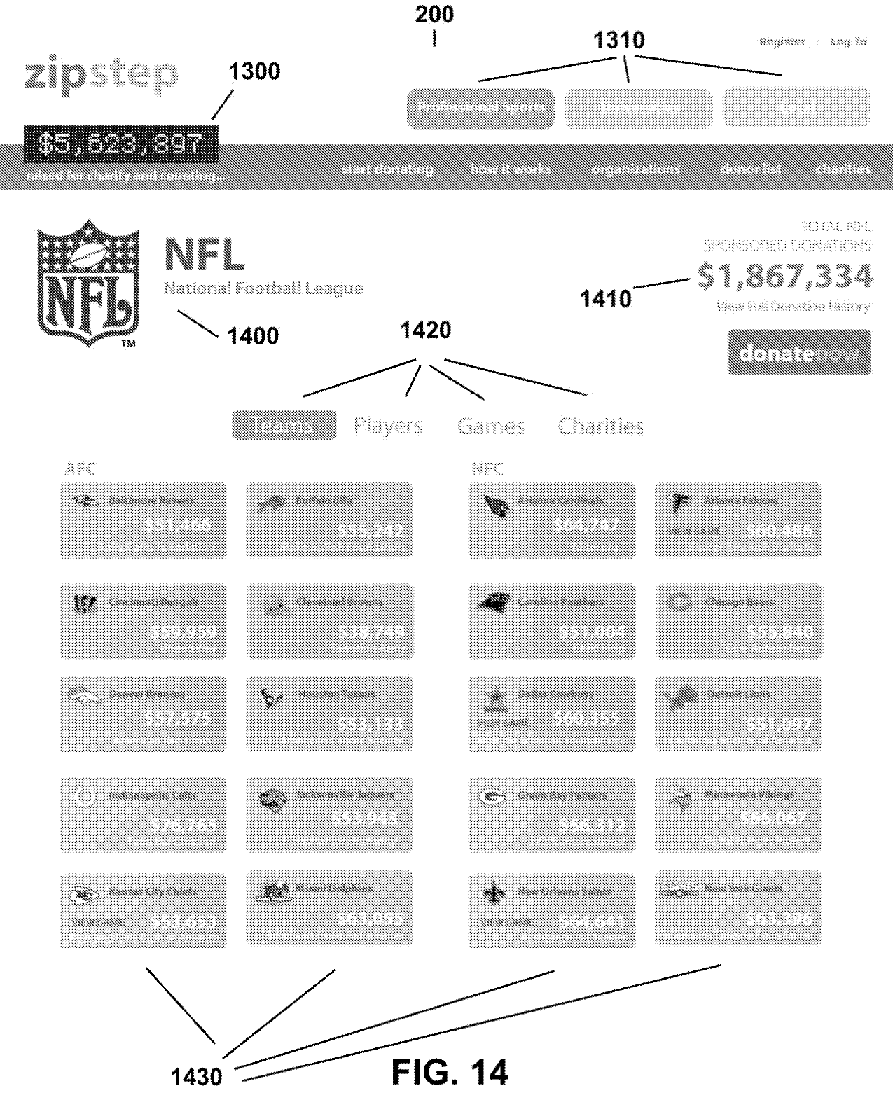

FIG. 14 is a screen shot of an interface for selecting a sports league team in which performance metrics are presented in real-time and can be selected for making donations in accordance with an embodiment of present inventive concepts. While the NFL was selected, this can be another professional sport league. A League Name Heading 1400 displays the league that is currently being viewed. A League Donation Counter 1410 displays the total amount of donations that the current league has generated through itself, its teams, and its athletes. A League Navigation Menu 1420 allows users to view the teams, players (athletes), games, and charities that are involved in the league. Although charities are listed, this can also include fundraisers that are not charities as well. In the current view, the team option is selected, so the Team Listing 1430 is displayed. The Team Listing 1430 lists all teams in the league, the donation amounts they have generated, and the current charity they are associated with.

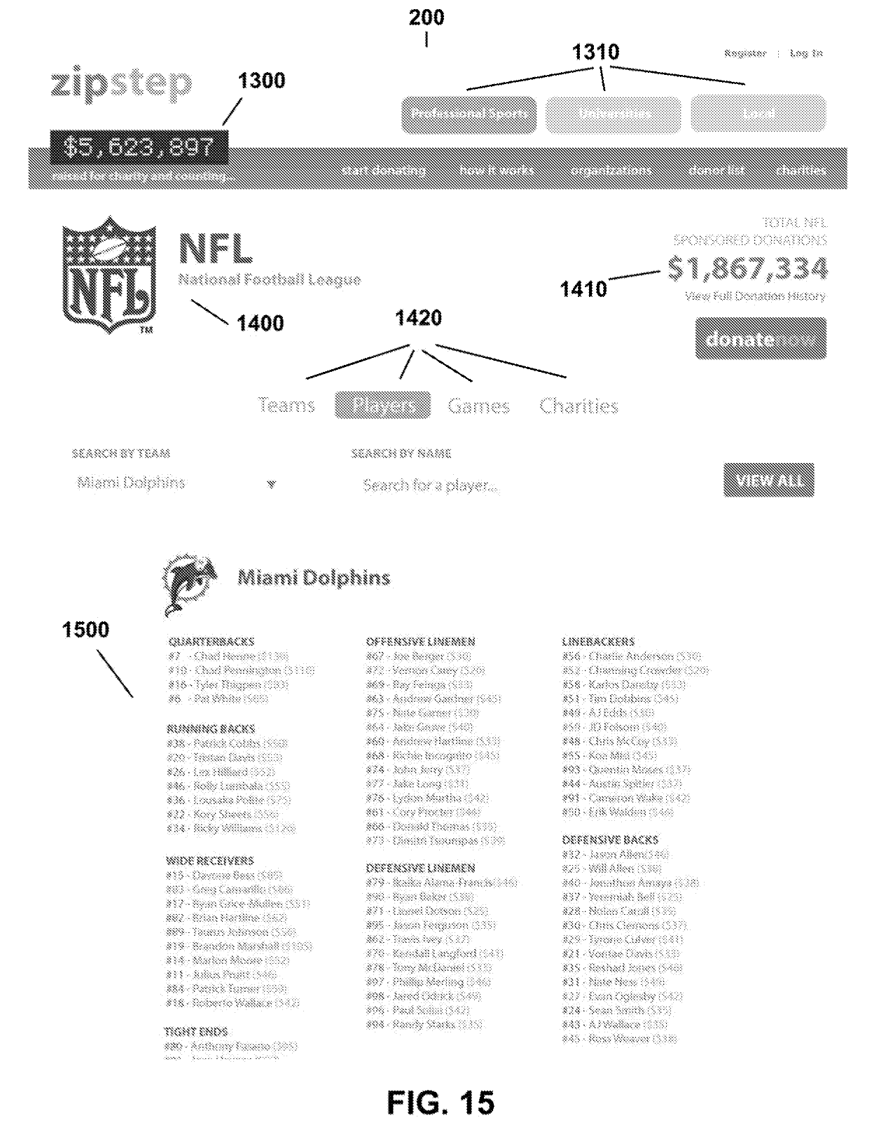

FIG. 15 is a screen shot of an interface for selecting a sports league player in which performance metrics can be selected for making donations in accordance with an embodiment of present inventive concepts. FIG. 15 depicts the NFL home page with the players option selected in the League Navigation Menu 1420. Just like the Team Listing 1430 displayed the teams within the league, the Players Listing 1500 displays the players within the league and the donations they have generated.

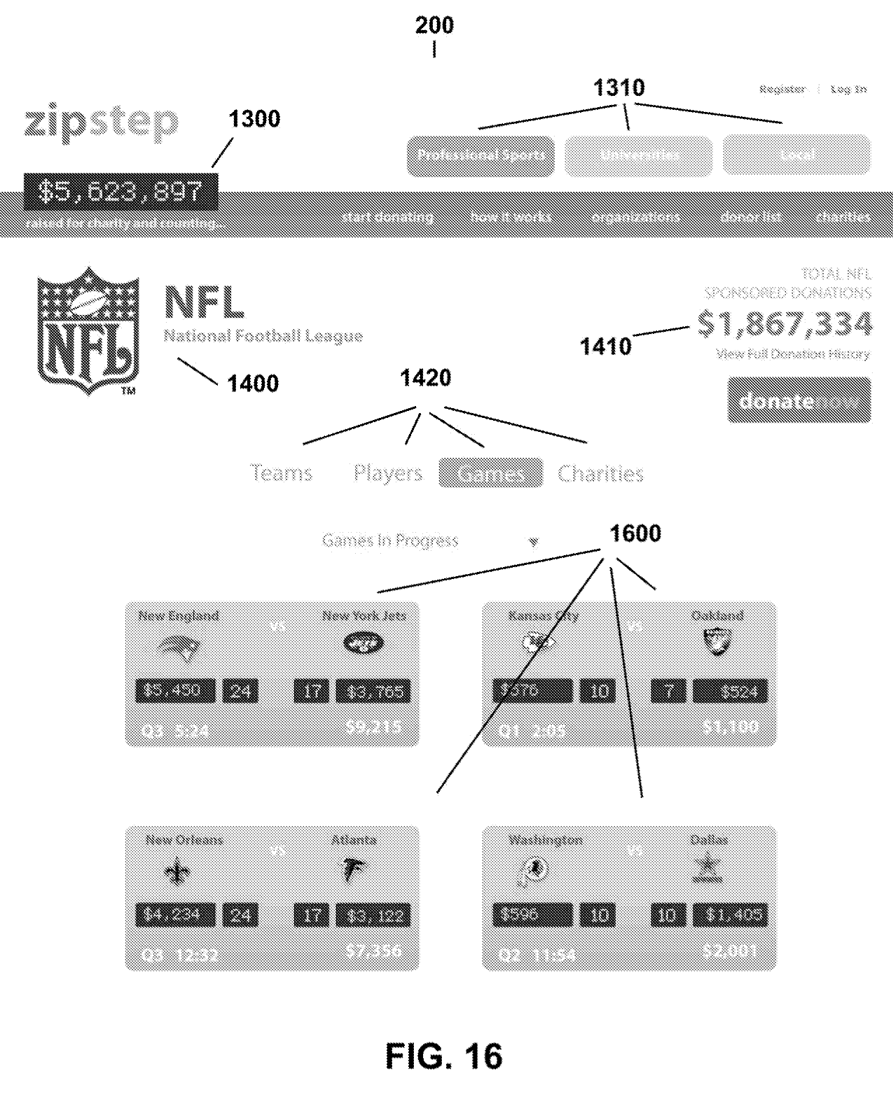

FIG. 16 is a screen shot of an interface providing a real-time update of competitions between organizations in which performance metrics can be selected for making donations in accordance with an embodiment of present inventive concepts. FIG. 16 depicts the NFL home page with the games option selected in the League Navigation Menu 1420. Just like the Player Listing 1500 displays the players within the league, the Games Listing 1600 displays games between teams that are both being used as Event Generating Entities. Users can view games that are currently ongoing as well as games that have already been completed. The games option allows users to see how teams stack up against each other in terms of donations generated during specific games. This can inspire competition and help to enhance user engagement as they support their favorite teams and athletes.

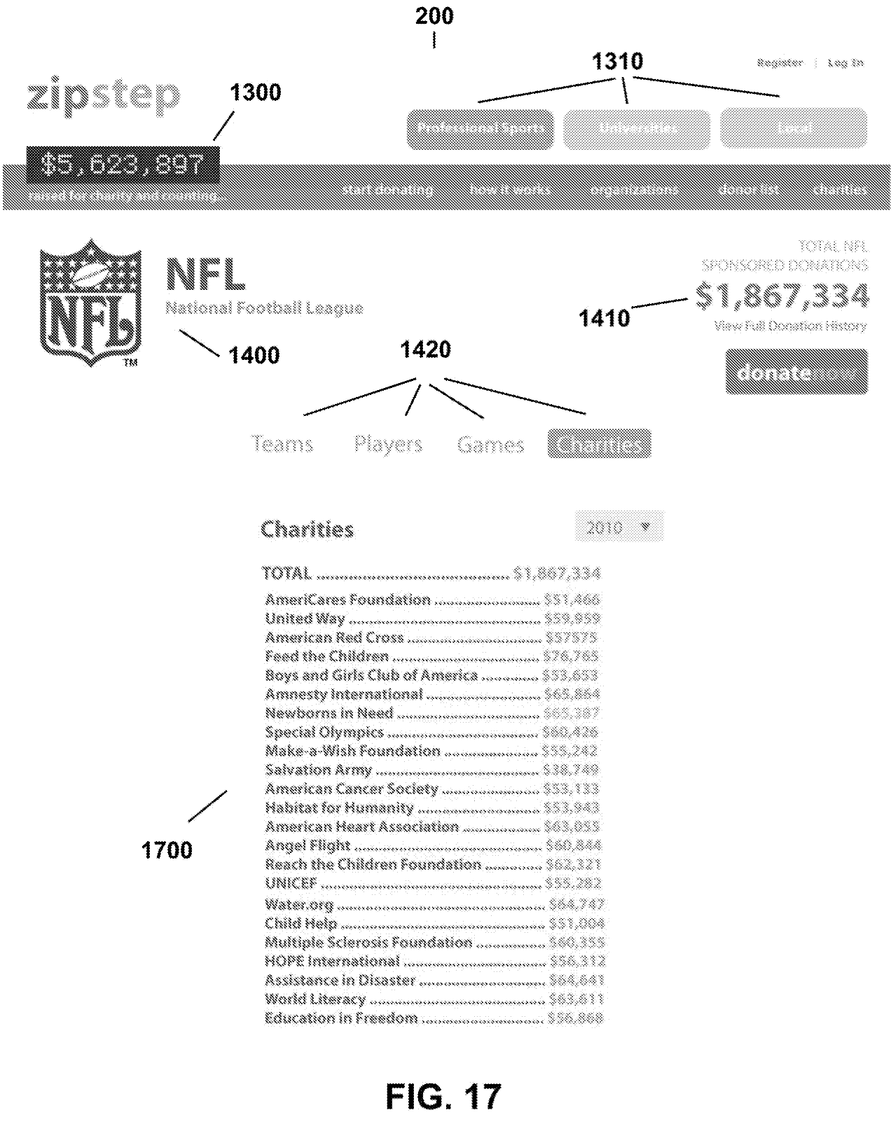

FIG. 17 is a screen shot of an interface providing a list of charities to which donations have been made in relation to a sports league in accordance with an embodiment of present inventive concepts. FIG. 17 depicts a fundraising system home screen for the NFL with the charities option selected in a League Navigation Menu 1420. Just as with the previous listings, a Charities Listing 1700 displays the charities that have been supported through donations generated through the NFL and the totals that have been raised. This listing can also be for fundraisers that are not charities.

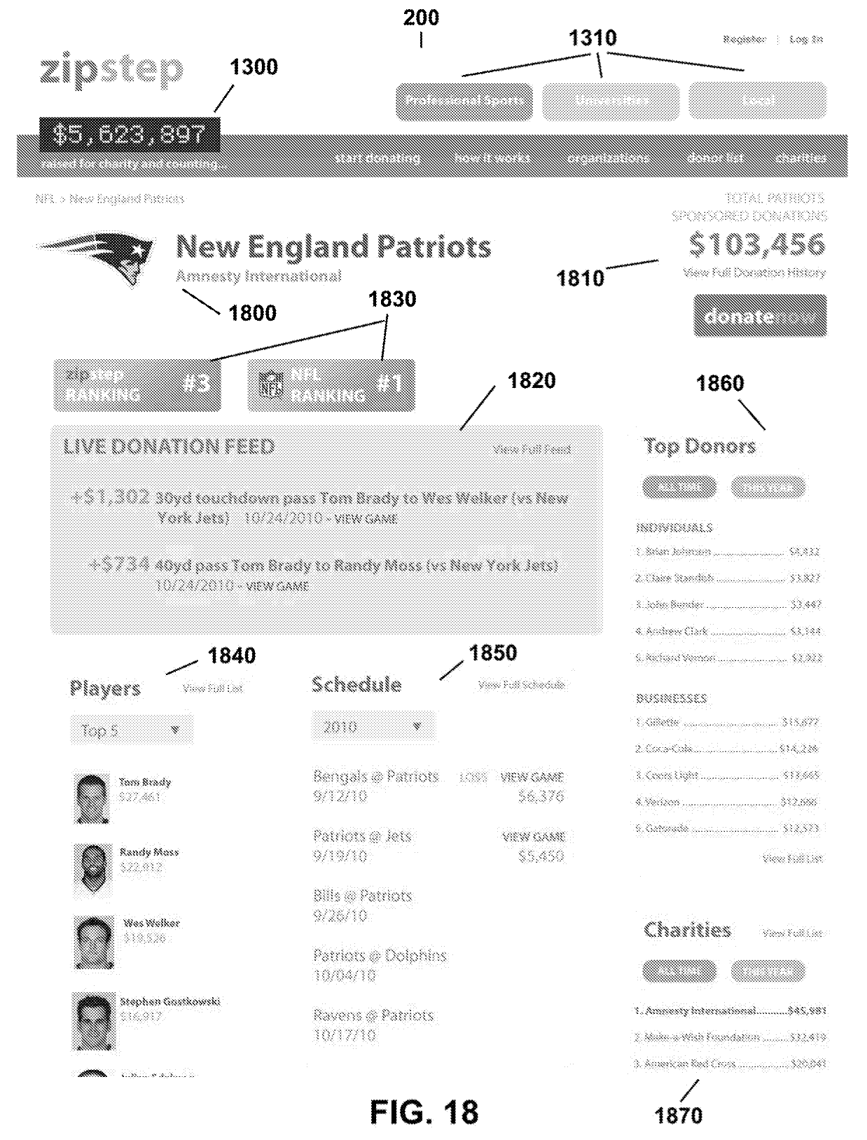

FIG. 18 is a screen shot of an interface providing a list of donations made with respect to performers and performance metrics of a sports team in accordance with an embodiment of present inventive concepts. FIG. 18 depicts, in particular, a fundraising system home screen of a selected team. In this case, the New England Patriots were selected. Similar in structure to the sports league home page, the team home page displays a Team Name Heading 1800, and a Team Donation Counter 1810 which displays the total amount of donations generated by the team and its players. A Ranking Labels 1830 display the current ranking (for donations generated) of the team system-wide and within the league. These are two examples of possible ranking standards, but rankings can be comprised of any standard that can be sufficiently measured against. The Team Live Donation Feed 1820 provides a real-time listing of donations the team is generating. It can update in real-time as donations are generated by the team and its players. The Top Players List 1840 displays the top donation generating players on the team. The Team Schedule 1850 displays upcoming games, and shows total donations generated through games that have been completed. The Team Top Donors List 1860 displays the top individual and business donors who have pledged donations using the current team and its players as Event Generating Entities. The Top Charities List 1870 displays the top charities ordered by the amount of donations that have been generated by the current team and its players on its behalf. This list can also be used to display top fundraisers in the event that the Fundraising Entity was not a charity.

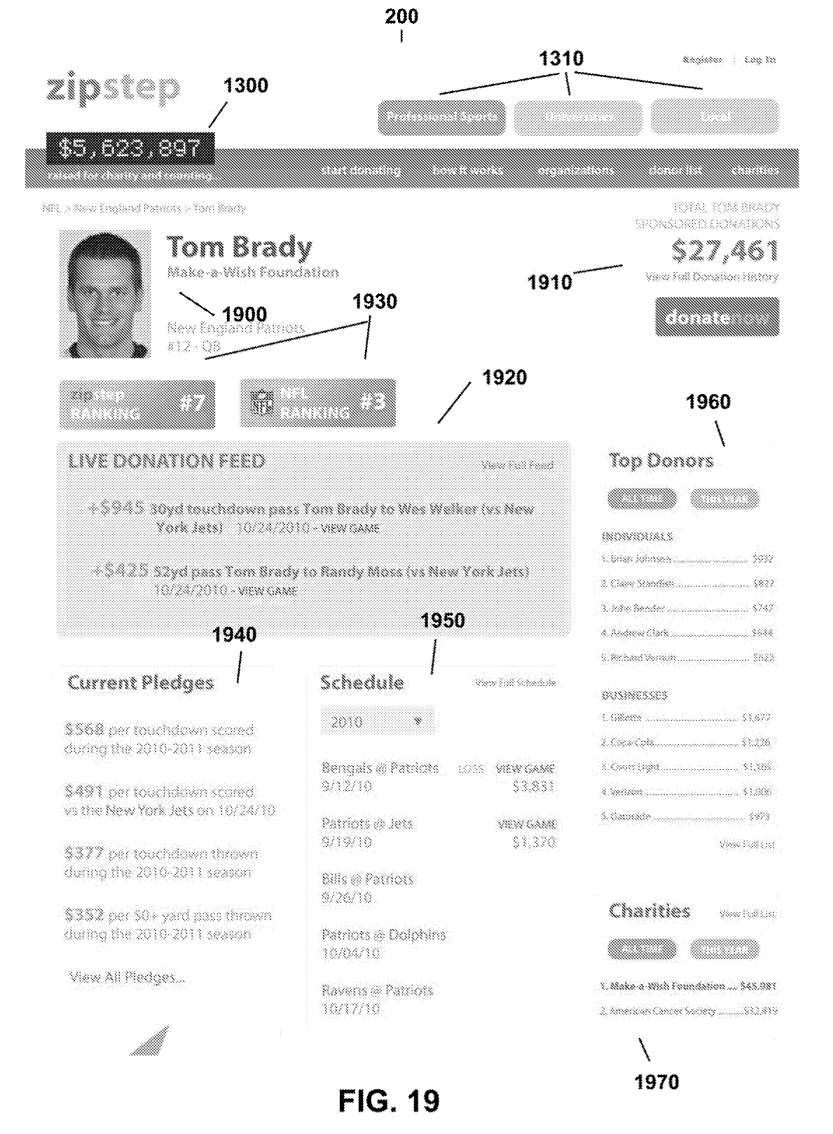

FIG. 19 is a screen shot of an interface providing a summary of donations made with respect to the performance metrics of a performer in accordance with an embodiment of present inventive concepts. In this case, Tom Brady is the selected athlete, but this can be any athlete or performer, as long as they can produce measureable performance events. Similar in structure to the sports league home page, the athlete home page displays an Athlete Name 1900, and an Athlete Donation Counter 1910 which displays the total amount of donations generated by the athlete. Ranking Labels 1930 display the current ranking (for donations generated) of the athlete system-wide and within the league. These are two examples of possible ranking standards, but rankings can be comprised of any standard that can be sufficiently measured against. An Athlete Live Donation Feed 1920 can provide a real-time listing of donations the athlete is generating. It can update in real-time as donations are generated by the athlete. A Top Current Pledges List 1940 displays the total amounts that are pledged against the athlete system-wide. An Athlete Schedule 1950 displays upcoming games, and shows total donations generated through games that have been completed. An Athlete Top Donors List 1960 displays the top individual and business donors who have pledged donations using the current athlete as the Event Generating Entity. A Top Charities List 1970 displays the top charities ordered by the amount of donations that have been generated by the current athlete on its behalf. This list can also be used to display top fundraisers in the event that the Fundraising Entity was not a charity.

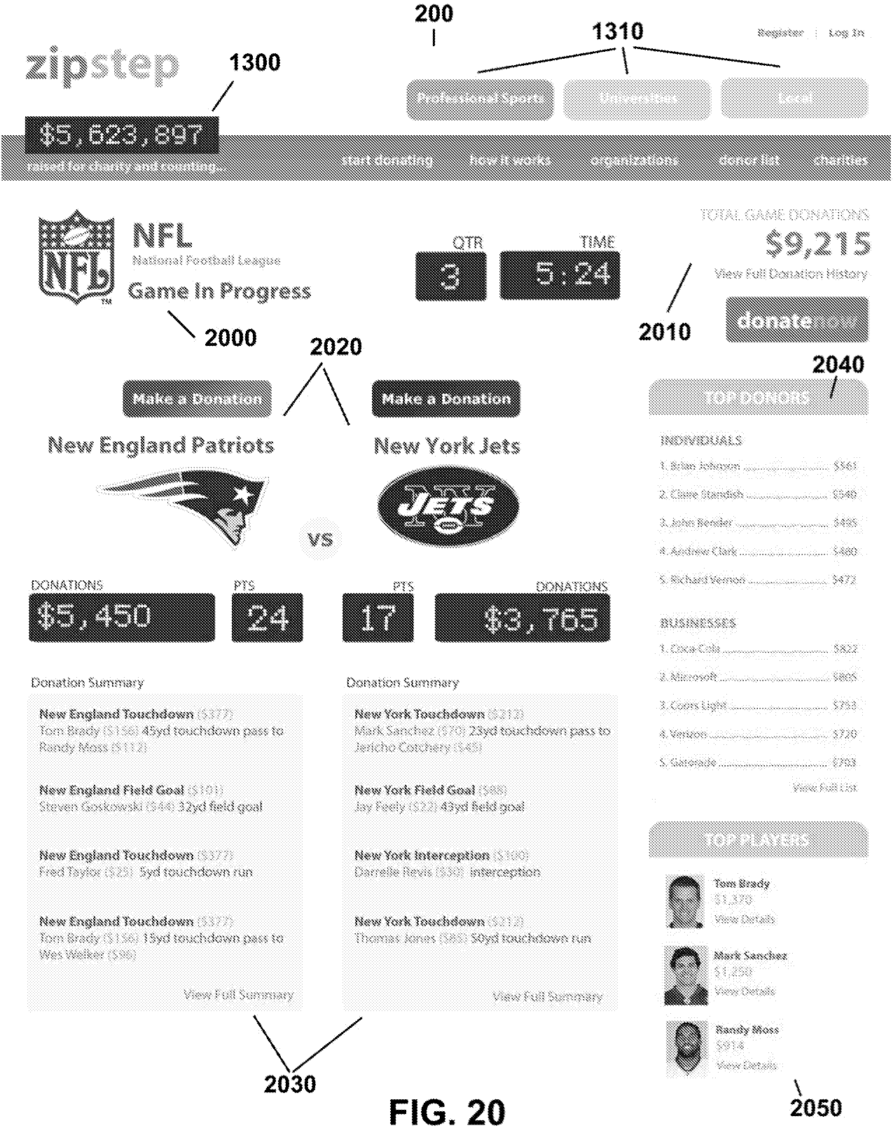

FIG. 20 is a screen shot of an interface providing a summary of donations made with respect to an ongoing competition between performers in accordance with an embodiment of present inventive concepts. FIG. 20 depicts a real time game in progress page, which provides detailed information for a game between two Event Generating Entities. A League Game Name 2000 displays the name of the league that the competing teams are a part of. A Game Donation Counter 2010 displays the total amount of donations that have been generated through the game. A Competing Teams Heading 2020 displays the two teams that are competing against each other and the total amount each has generated thus far in the game. A Donation Summaries 2030 shows the most recent performance metrics in the game that have generated donations, the players involved, and the total donations generated by the event. A Game Top Donors List 2040 displays the top individual and business donors who have pledged donations using the current game as their Donation Generating Event 420. A Game Top Players List 2050 displays the top players that have generated donations in the game ordered by highest amount.

In an embodiment, user engagement may be further enhanced through a robust ranking system, where Event Generating Entities, which in a sports driven embodiment may include, but are not limited to, sports leagues, sports teams, and athletes, are ranked according to the donations they have generated. In an embodiment, the ranking system is searchable and filterable, so users can search for rankings by any number of relevant criteria, including, but not limited to, the Event Generating Entity type and name, city, state, date range, and donation amount.

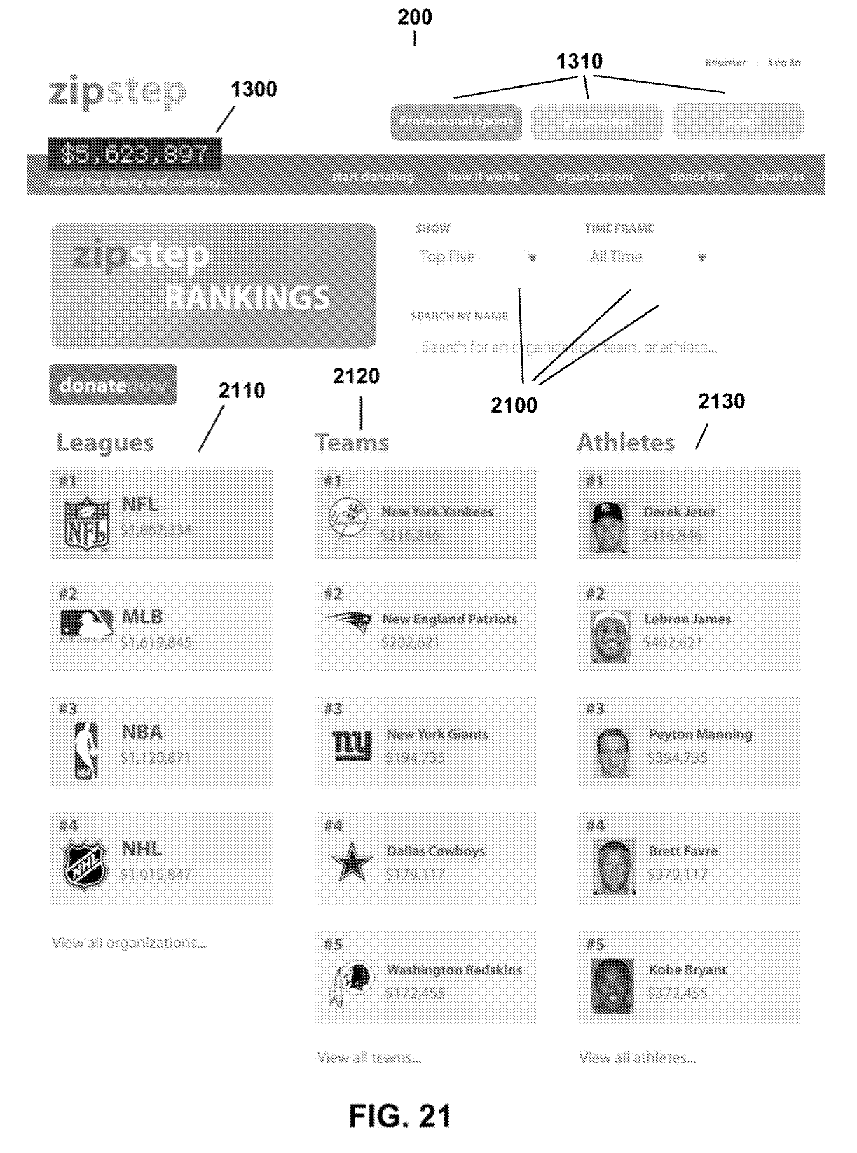

FIG. 21 is a screen shot of an interface providing a ranking of donations made with respect to sports leagues, sports teams, and the players of the teams in accordance with an embodiment of present inventive concepts. FIG. 21 illustrates a ranking system presented through a GUI 200. Ranking Search Selector inputs 2100 allows users to select specific ranking information for display. A League Rankings list 2110 displays the top ranked leagues based on the donations generated and the total amount generated. A Team Rankings list 2120 displays the top ranked teams across all leagues based on the donations generated and the total amount generated. An Athletes Rankings list 2130 displays the top ranked athletes across all leagues based on the donations generated and the total amount generated.

In an embodiment, user engagement may be further enhanced through an operators ability to access a donor directory to view real time donation history of Donors/Pledgors, and see the details of their donations. In an embodiment, Donors/Pledgors can have the option to be listed as anonymous if they do not want their names publicly viewable. Donor/Pledgor data can be searchable and filterable, so users can search for donors by any number of relevant criteria, including, but not limited to, name, city, state, Event Generating Entity used, date range, and donation amount.

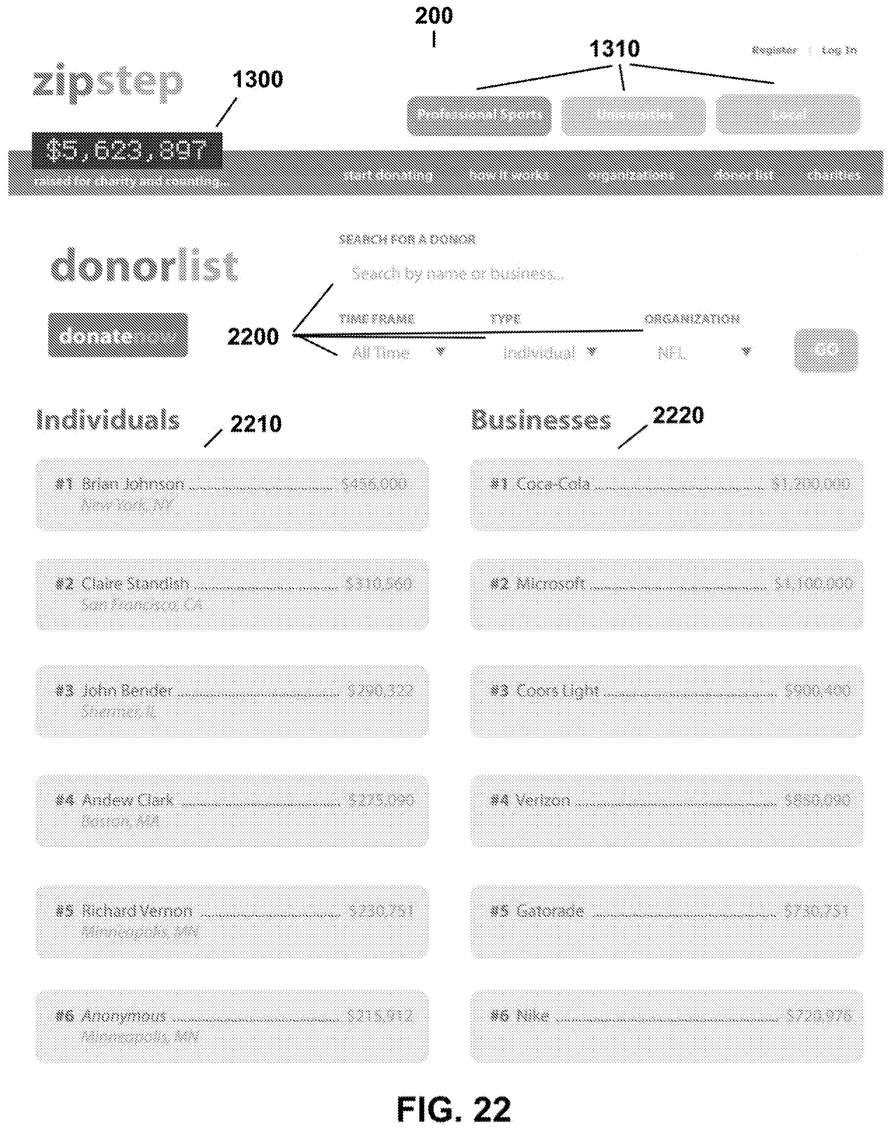

FIG. 22 illustrates a donor directory presented through a graphical user Interface according to an embodiment. FIG. 22 further provides a ranking of donations made by a list of various individuals and businesses in accordance with an embodiment. A Directory Search Tool 2200 allows users to drill down and search for specific donor information. An Individual Listing 2210 displays a listing of the top individual donors system-wide, their locations, and the total amount donated. A Business Listing 2220 displays a listing of the top business donors system-wide, their locations, and the total amount donated.

In various embodiments, user engagement may be further enhanced through support of donation widgets, wherein a “widget” is known to one of ordinary skill in the art as a stand-alone dynamic application that can be embedded into web sites or operating systems such as, for example, on portable computing devices such as cell phones, tablets, etc. . . . In an embodiment, a widget allows operators to display virtual badges on external Internet interfaces that display real time donation information pertaining to selected Donors, Fundraising Clients, Event Generating Entities, and Donation Generating Events. In a sports driven embodiment Event Generating Entities 410 may include, but are not limited to sports leagues, sports teams, and athletes. Donation Generating Events 420 may include, but are not limited to, single games or events, entire seasons, or specific series. In an embodiment, the widgets can be integrated with, for example, websites and/or social networking applications. Widgets can be supported by providing code snippets and/or downloadable web applications that can be inserted and installed into external interfaces. Widgets can include “virtual badges”, which display information about donations made through a fundraising system in accordance with present inventive concepts. In an embodiment, widgets and/or applications may act partially or completely independently from a central fundraising system server.

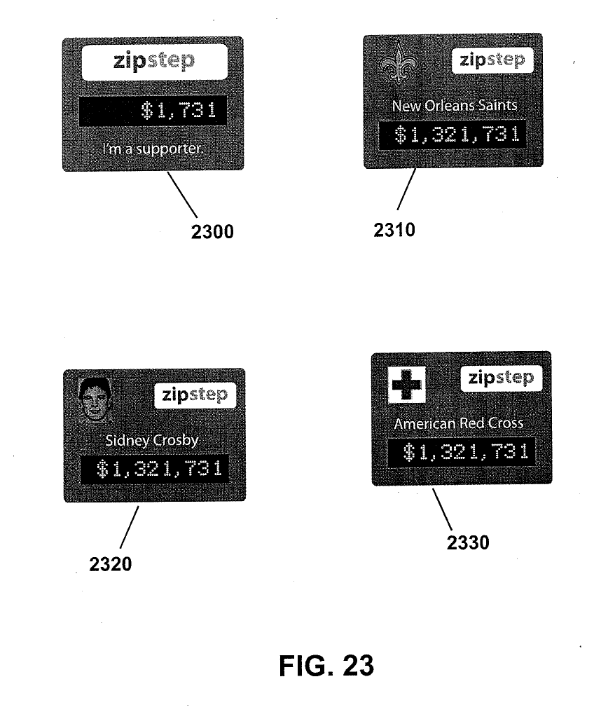

FIG. 23, for example, illustrates designs of “virtual badges.” FIG. 23, in particular, is a screen shot of an interface providing virtual badges including donation amounts with respect to donors or with respect to performers of performance metrics in accordance with an embodiment of present inventive concepts. A Donor Badge 2300 displays the total amount donated by a particular Donor/Pledgor. A Team Badge 2310 displays the total amount of donations generated by a selected team (in this case the New Orleans Saints). An Athlete Badge 2320 displays the total amount of donations generated by a selected athlete (in this case Sidney Crosby). A Charity Badge 2330 displays the total amount donated to the selected charity (in this case the Red Cross). In an embodiment, the virtual badges can update in real time. While these badges display specific examples of donors, teams, athletes, and charities, a virtual badge can be created out of any entity that interacts with the system that, for example, donates, generates pledges, or receives donations.

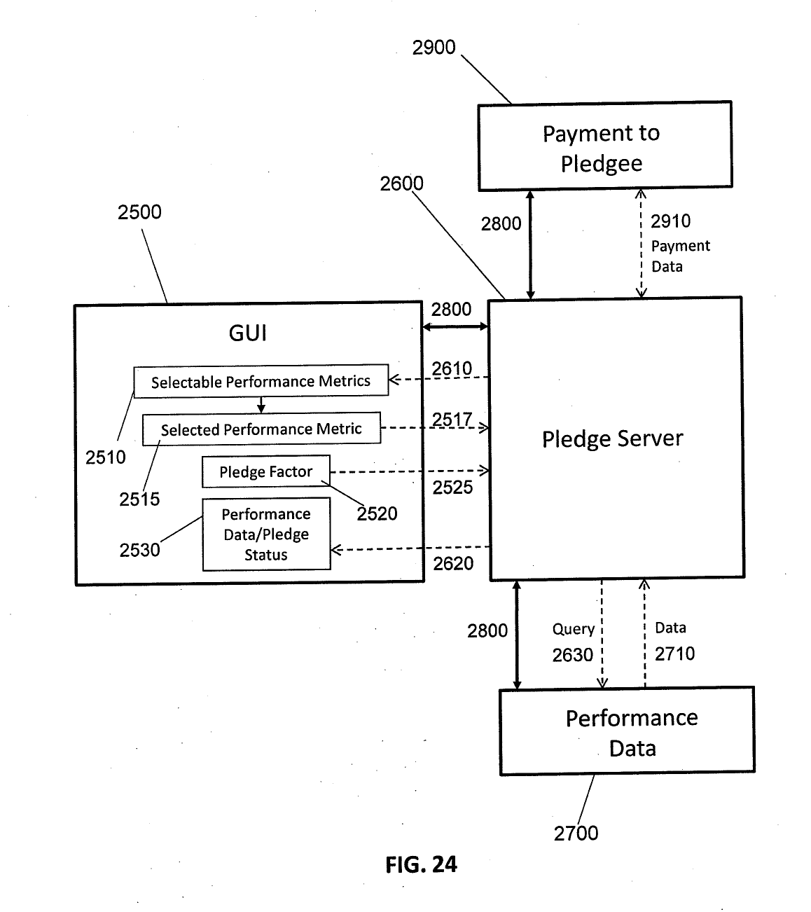

FIG. 24 is a high level block diagram illustrating data and process flow within a system for facilitating donations in accordance with an embodiment of present inventive concepts. A Pledge Server 2600 facilitates operation, through a network connection 2800, of a Graphical User Interface (GUI) 2500 that interacts with a Donor/Pledgor for making pledges and donations through the Pledge Server 2600. Through the GUI 2500, the Pledge Server provides, via network transmissions 2610, Selectable Performance Metrics 2510 that are presented to a donor/pledgor for selecting a performance metric for which a pledge/donation may be made in relation to a measurement of the performance metric. Once the donor/pledgor selects a performance metric, a Selected Performance Metric 2515 is sent, via network transmissions 2517, to the Pledge Server 2600. The GUI 2500 also prompts the donor/pledgor for a Pledge Factor 2520, which can be sent to the Pledge Server 2600 via network transmissions 2525. Once provided with a Selected Performance Metric 2515, the Pledge Server 2600 may periodically or continuously execute a query 2630 through a network connection 2800, in order to receive and/or update, via network transmissions 2710, Performance Data 2700 pertaining to the Selected Performance Metric 2515. The Pledge Server 2600 can verify if the Performance Data 2700 is complete and/or accurate for updating the donor/pledgor and/or calculating an interim or final pledge/donation, wherein the pledge may be calculated by factoring the Selected Performance Metric 2515 with the Pledge Factor 2520. The Pledge Server 2600 can then update, via network transmissions 2620, the donor/pledgor with information about pending or completed pledges/donations. In an embodiment, the Pledge Server 2600 can also facilitate Payment 2900 of a donation to a pledgee via a network connection 2800 and transmissions 2910.

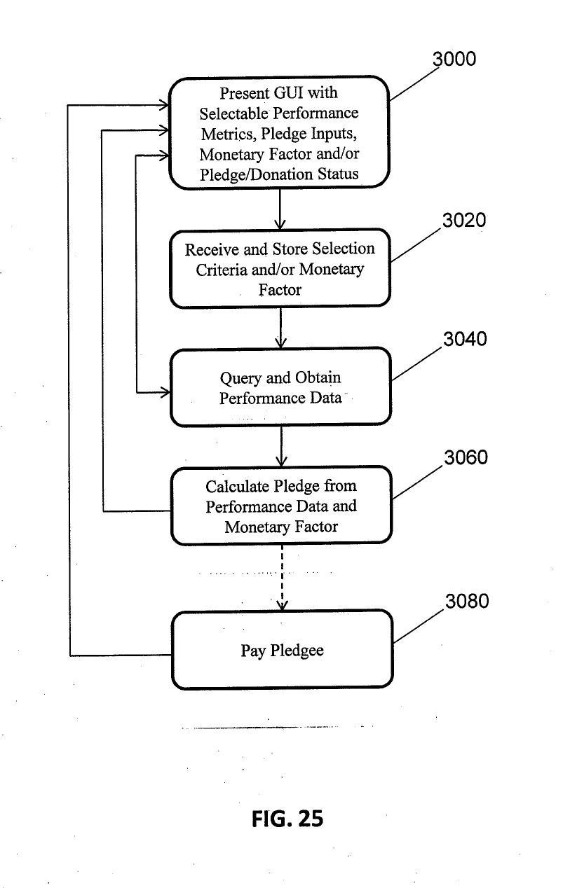

FIG. 25 is a high level block diagram illustrating process flow within a system for facilitating donations in accordance with an embodiment of present inventive concepts. The process includes the step 3000 of presenting a GUI with Selectable Performance Metrics and Pledge Inputs and may further include Pledge Status updates. A pledgor/donor can select a performance metric and a factor of monetary value (e.g., see FIGS. 8-9 and accompanying description above) for making a pledge based on the performance metric and the factor of monetary value. A next step 3020 includes receiving and storing the performance metric and factor of monetary value in computer readable memory (e.g., on a pledge server). A further step 3040 includes querying (e.g., through the Internet) and obtaining performance data pertaining to the performance metric. For example, performance data about athletic events (e.g., scores, statistics, etc. . . . ) can be obtained remotely through various Internet resources such as news wire services, team or league websites, etc. . . . by programming a server or other device connected to the Internet to do so in accordance with an embodiment of inventive concepts. The performance data can be presented through a GUI as in the initial step 3000 above. A further step 3060 includes calculating a pledge amount based on the performance metric, factor of monetary value, and obtained performance data pertaining to the performance metric. In an embodiment, the obtained performance data may require intermediate processing (e.g., summation, averaging, etc.) prior to applying the factor of monetary value. For example, the batting average of a baseball player during a game may not be directly available from an Internet resource but could be calculated from the number of times at bat, the number of times walked, the number of hits, etc. during a particular game, which may be more immediately available from Internet resources. Once information about a pending pledge has been determined (e.g., measured performance data, currently pledged amounts), this information can be presented through the GUI as in step 3000. In a further step 3080, payment of the pledge amount can be facilitated to the Pledgee such as described in various embodiments herein. Donations made by the pledgor/donor can be presented and summarized to a user.

While many of the examples and embodiments used in the above paragraphs are based on sports and sport related entities, this was not intended to imply that such a system would be used exclusively for such purposes. Any reference to a sport related Event Generating Entity 410, a Donation Generating Event 420, or Performance Metric 430 could be replaced with any other Event Generating Entity 410, Donation Generating Event 420, or Performance Metric 430 that qualifies as such. Examples of possible Event Generating Entities 410 may include, but are not limited to, professional sports leagues, professional sports teams, professional athletes, collegiate sports leagues/divisions, collegiate sports teams, collegiate athletes, local sports leagues, local sports teams, local athletes, Olympic teams, Olympic athletes, the stock market, individual stocks, stock portfolios, stock indices, bands/performers, actors, movie studios, award ceremonies, politicians, political parties, websites, and fundraising entities themselves. Examples of possible Donation Generating Events 420 may include, but are not limited to, athletic events, athletic competitions, games, races, daily activity of a stock market, monthly activity of individual stocks, yearly activity of a stock indices, a music concert, a music tour, activity of an actor over a given time period, opening weekend of a movie, an election, a debate, and a fundraising campaign. Performance Metrics 430 may include, but are not limited to any Performance Metrics 430 that may arise from such Event Generating Entities 410 and Donation Generating Events 420. Examples include: games won, dollar increase of a particular stock, percentage increase of a stock market, number of tickets sold to a movie, votes generated by a political party, or donations raised by a fundraiser.

While embodiments of the inventive concepts have been particularly shown and described with references to preferred embodiments thereof, it will be understood by those skilled in the art that various changes in form and details may be made herein without departing from the spirit and scope of the inventive concepts as defined by the appended claims.

1. A method of facilitating pledges of monetary value between a pledgee and pledgor, the method comprising the steps of:
providing a graphical user interface having a plurality of selectable performance metrics and at least one input for a factor of monetary value;
receiving a selected performance metric of the plurality of performance metrics and the at least one input for a factor of monetary value;
transmitting and storing the received selected performance metric and the received input of a factor of monetary value to computer readable memory of a computer server system;
periodically querying and obtaining a measured value of the selected performance metric and storing said measured value in the computer readable memory of the computer server system; and,
calculating a pledge amount of monetary value by applying said factor of monetary value to the measured value of the selected performance metric and storing the pledge amount of monetary value in the computer readable memory of the computer server system.

2. The method of claim 1 wherein the plurality of selectable performance metrics comprise a statistic pertaining to athletic competition.

3. The method of claim 2 wherein the plurality of selectable performance metrics comprise a statistic pertaining to a professional sports league.

4. The method of claim 3 wherein the statistic pertaining to a professional sports league comprises at least one statistic pertaining to the National Football League, Major League Baseball, National Hockey League, and National Basketball Association.

5. The method of claim 4 wherein the statistic pertaining to a professional sports league comprises at least one of games won, races won, touchdown passes scored, field goals scored, home runs hit, strike outs pitched, bases stolen, three point shots scored, free throws scored, birdies made, golf drives over 300 yards, knock outs during a fighting match, and submissions during a fighting or wrestling match.

6. The method of claim 2 wherein plurality of selectable performance metrics comprise a statistic pertaining to amateur or college athletics.

7. The method of claim 1 wherein the plurality of selectable performance metrics comprises a statistic pertaining to activity of the stock market

8. The method of claim 1 wherein the statistic pertaining to activity of the stock market comprises at least one of daily activity of the stock market, activity of individual stocks, and yearly activity of stock indices.

9. The method of claim 1 wherein the plurality of selectable performance metrics comprises artistic entertainment.

10. The method of claim 9 wherein the artistic entertainment comprises at least one of a music concert, a music tour, a television show, activity of an actor over a given time period, and the opening weekend of a movie.

11. The method of claim 1 wherein the plurality of selectable performance metrics comprises political activity.

12. The method of claim 11 wherein the political activity includes at least one of an election, a debate, and a political fundraiser.

13. The method of claim 1 wherein the querying and obtaining a measured value comprises querying and obtaining a measured value from a wide-area computer network.

14. The method of claim 13 wherein the wide-area computer network is the Internet.

15. The method of claim 13 wherein obtaining a measured value comprises querying and obtaining one or more secondary values different from the measured value and calculating the measured value from the one or more secondary values.

16. The method of claim 15 wherein the measured value is at least one of the average and sum value of the secondary values.

17. The method of claim 1 further comprising determining at least one statistic of pledges in relation to one or more performance metrics.

18. The method of claim 17 wherein the graphical user interface displays the at least one statistic.

19. The method of claim 17 wherein the at least one statistic comprises a rank based on the monetary value of pledges pertaining to one or more elements of one or more performance metrics.

20. The method of claim 17 wherein the at least one statistic comprises a sum of pledges made in relation to a team, player, or performer that is the performer of the performance metric.

21. The method of claim 17 wherein the statistic comprises a sum of pledges made in relation to a particular pledgee and performance metric.

22. The method of claim 1 wherein the receiving a selected performance metric and the at least one input for a factor of monetary value further comprises receiving a pledge term during which the selected performance metric was performed.

23. The method of claim 22 wherein the pledge term comprises a term of at least one of one or more individual games or events, one or more seasons, one or more playoffs of one or more seasons, and a career of a performer or competitor.

24. The method of claim 22 wherein the receiving a pledge term comprises receiving a term that is initially open-ended and wherein the open-ended term can later be ended by receiving input from an operator.

25. The method of claim 1 wherein the receiving a selected performance metric and the at least one input for a factor of monetary value comprises receiving an information package of pledge attributes, the package of pledge attributes comprising a subject of the performance metric, the pledge term, the performance metric, and the factor of monetary value.

26. The method of claim 1 wherein the periodically querying and obtaining a measured value of the selected performance metric and storing said measured value in the computer readable memory is performed continuously during at least one interval of time.

27. The method of claim 1 wherein the periodically querying and obtaining a measured value of the selected performance metric comprises querying and obtaining an intermediate status related to the performance metric.

28. The method of claim 27 wherein the intermediate status comprises a status during an ongoing competition.

29. The method of claim 27 wherein the intermediate status comprises at least one of leaders of an ongoing race or tournament and score of an ongoing game or match.

30. The method of claim 1 wherein the graphical user interface comprises permitting an operator to perform the querying and obtaining of a measured value immediately in response to a command from the operator.

31. The method of claim 1 further comprising facilitating a payment of the pledge of monetary value from the pledgor to the pledgee.

32. The method of claim 31 wherein facilitating payment comprises collecting funds via at least one of a credit card account transaction, debit card account transaction, checking account transaction, money order, ACH transfer, wire transfer, and PayPal.

33. The method of claim 1 wherein providing a graphical user interface comprises providing an application on a networked device and wherein the application incorporates the graphical user interface.

34. The method of claim 33 wherein the networked device is a portable device.

35. The method of claim 33 wherein the application is an Internet Web Browser.

36. The method of claim 33 wherein the application is a widget.

37. The method of claim 33 wherein the networked device is programmed to operate as the computer server.

38. The method of claim 1 further comprising identifying the tax-exempt status of the pledgor.

39. The method of claim 1 further comprising generating a form for identifying a donation as a tax-deductible gift to a charitable organization.

40. A system for facilitating pledges of monetary value between a pledgee and pledgor, the system comprising at least one computer server having computer readable memory and a network interface, the at least one computer server programmed to facilitate display of a graphical user interface, the graphical user interface having at least one input with a plurality of selectable performance metrics and at least one input for a factor of monetary value, and wherein the at least one computer server is further programmed to:
receive a selection of the selectable performance metrics and a factor of monetary value entered from the at least one input;
store the selectable performance metrics and a factor of monetary value in the computer readable memory;
receive a measured value of the selection of the selectable performance metrics and store said measured value in the computer-readable memory of the computer server;
periodically query and obtain through the network interface a measured value of the selected performance metric and storing said measured value in the computer readable memory of the computer server; and
calculate a pledge amount of monetary value by applying said factor of monetary value to said measured value of the selected performance metric and storing the pledge amount of monetary value in the computer readable memory of the computer server.

41.-79. (canceled)
